(19) United States
(12) Patent Application Publication
(10) Pub. No.: US 2020/0219043 A1
(43) Pub. Date: Jul. 9, 2020

(54) NETWORKED SYSTEM INCLUDING A RECOGNITION ENGINE FOR IDENTIFYING PRODUCTS WITHIN AN IMAGE CAPTURED USING A TERMINAL DEVICE

(71) Applicant: GoSpotCheck Inc., Denver, CO (US)

(72) Inventors: Matthew Talbot, Denver, CO (US); Samantha Holloway, Denver, CO (US); Joseph Alfano, Denver, CO (US); Daniel Augustus Pier, Denver, CO (US); Goran Matko Rauker, Denver, CO (US); Matthew Reid Arnold, JR., Denver, CO (US)

(21) Appl. No.: 16/734,183

(22) Filed: Jan. 3, 2020

Related U.S. Application Data
(60) Provisional application No. 62/788,895, filed on Jan. 6, 2019.
(60) Provisional application No. 62/791,543, filed on Jan. 11, 2019.

(51) Int. Cl. G06Q 10/08; G06F 16/54; G06K 7/14; G06N 20/00; G06K 9/20; G06K 9/22; G06K 9/32

(52) U.S. Cl. CPC G06Q 10/087; G06F 16/54; G06K 7/1413; G06K 9/32; G06K 9/2081; G06K 9/22; G06N 20/00

(57) ABSTRACT

A method of capturing and providing, with a mobile device, images of retail products for analysis by a remote image analysis engine applying one or more machine learning models, may include, at a mobile device comprising a processor, a memory, a display, and an integrated camera, prompting a user to capture an image of an array of physical items, capturing the image with the integrated camera, and sending the captured image to a remote server. The method may further include receiving an image annotation data set defining an array of segments, each segment corresponding to a physical item in the array of physical items and having an associated product information, a given associated product information determined using a trained product model that identifies a product identifier based on a portion of the image that corresponds to a given segment of the image.

### CROSS-REFERENCE TO RELATED APPLICATION(S)

This application is a nonprovisional patent application of and claims the benefit of U.S. Provisional Patent Application No. 62/788,895, filed Jan. 6, 2019 and titled “Networked System Including A Recognition Engine For Identifying Products Within An Image Captured Using A Terminal Device,” and U.S. Provisional Patent Application No. 62/791,543, filed Jan. 11, 2019 and titled, “Networked System Including A Recognition Engine For Identifying Products Within An Image Captured Using A Terminal Device,” the disclosures of which are hereby incorporated herein by reference in their entireties.

### FIELD

The described embodiments relate generally to systems and methods for capturing images of physical items and deriving compliance metrics from the captured images using an image analysis engine.

### BACKGROUND

Suppliers of products, such as food and beverage products, establish targets and guidelines for the presentation of their products in stores. For example, a beverage supplier may desire to have their products presented prominently in the refrigerated display cases at convenience stores. In some cases, suppliers may have agreements with retail outlets regarding how the suppliers' products are to be displayed.

### SUMMARY

A method of capturing and providing, with a mobile device, images of retail products for analysis by a remote image analysis engine applying one or more machine learning models, may include, at a mobile device comprising a processor, a memory, a display, and an integrated camera, prompting a user to capture an image of an array of physical items, capturing the image with the integrated camera, and sending the captured image to a remote server. The method may further include receiving, from the remote server, an image annotation data set defining an array of segments, each segment corresponding to a physical item in the array of physical items and having an associated product information, a given associated product information determined using a trained product model that identifies a product identifier based on a portion of the image that corresponds to a given segment of the image. The method may further include receiving, from the remote server, information representing an amount of the physical items in the array of physical items that are associated with a particular product identifier. The method may further include displaying, on the display, an annotated image based on the captured image and the image annotation data set received from the remote server, and displaying, on the display, the information representing the amount of the physical items in the array of physical items that are associated with the particular product identifier.

The trained product model may be a first trained product model, and the segments may be determined by providing the image as an input to a second trained product model and receiving, from the second trained product model, a segmented image in which each segment corresponds to a physical item in the array of physical items.

The method may further include displaying a preview image of a physical item in the annotated image, prompting the user to associate a verified product identifier with the preview image, receiving the verified product identifier, sending the verified product identifier to the remote server, and receiving, from the remote server, updated information representing the amount of the physical items in the array of physical items that are associated with the particular product identifier.

The method may further include displaying a preview image of a physical item in the annotated image, prompting the user to capture an image of a barcode of the physical item, and capturing the image of the barcode using a camera function of the mobile device. The method may further include sending the image of the barcode to the remote server. The method may further include determining a product identifier from the image of the barcode, and sending the product identifier to the remote server to be associated with the preview image of the physical item in the annotated image.

The method may further include receiving, from the remote server, compliance information representing a comparison between the amount of the physical items in the array of physical items that are associated with the particular product identifier and a target amount, and displaying the compliance information on the display. The method may further include receiving, from the remote server, an action item associated with the particular product identifier, wherein compliance with the action item will reduce a difference between the amount of the physical items in the array of physical items that are associated with the particular product identifier and a target amount. The compliance information may further represent a comparison between locations of the physical items in the array of physical items that are associated with the particular product identifier and target locations.

The method may further include, at the mobile device, prompting the user to capture an additional image of an additional array of physical items, capturing the additional image with the integrated camera, sending the additional image to the remote server, and receiving, from the remote server, an additional image annotation data set representing an additional array of segments each corresponding to a physical item in the additional array of physical items and having an associated product identifier, and additional information representing an amount of the physical items in the additional array of physical items that are associated with a particular product identifier. The method may further include displaying, on the display, an additional annotated image based on the additional image and the additional image annotation data set received from the remote server, and displaying, on the display, the additional information representing the amount of the physical items in the additional array of physical items that are associated with the particular product identifier. The method may further include combining the information representing the amount of the physical items in the array of physical items that are associated with the particular product identifier and the additional information representing the amount of the physical items in the additional array of physical items that are associated with the particular product identifier, and displaying the combined information on the display.

A method of analyzing images of physical items captured via a mobile device may include receiving, at a server and via a mobile device, a digital image of an array of products, and determining, in the digital image, a plurality of segments, each segment corresponding to a product in the array of products. The method may further include, for a segment of the plurality of segments, determining a candidate product identifier and determining a confidence value of the candidate product identifier. The method may further include, if the confidence value satisfies a condition, associating the candidate product identifier with the segment and sending candidate product information, based on the candidate product identifier, to the mobile device for display in association with the segment. The method may further include, if the confidence value fails to satisfy the condition, subjecting the segment to a manual image analysis operation.

The method may further include receiving, as a result of the manual image analysis operation, a verified product identifier, associating the verified product identifier with the segment, and sending verified product information, based on the verified product identifier, to the mobile device for display in association with the segment. The operation of determining the plurality of segments in the digital image may include analyzing the digital image using a machine learning model trained using a corpus of digital images, and the digital images may each include a depiction of a respective array of products and the digital images may each be associated with a respective plurality of segments, each segment corresponding to an individual product.

The machine learning model may be a first machine learning model, the digital images may be first digital images, the operation of determining the candidate product identifier of the segment may include analyzing the segment using a second machine learning model trained using a corpus of second digital images, and the second digital images each include a depiction of a respective product and are associated with a respective product identifier.

A method of analyzing images of physical items captured via a mobile device may include receiving, at a server and via a mobile device, a digital image of an array of products, and determining, in the digital image, a plurality of segments, each segment corresponding to a product in the array of products. The method may further include, for a first segment of the plurality of segments, determining a first candidate product identifier, determining that a confidence value of the first candidate product identifier satisfies a condition, and in response to determining that the first candidate product identifier satisfies the condition, associating the first candidate product identifier with the first segment and sending first product information to the mobile device for display in association with the first segment, the first product information based on the first candidate product identifier. The method may further include, for a second segment of the plurality of segments, determining a second candidate product identifier, determining that a confidence value of the second candidate product identifier fails to satisfy the condition, and in response to determining that the second candidate product identifier fails to satisfy the condition, subjecting the second segment to a manual image analysis operation.

The method may further include receiving, as a result of the manual image analysis operation, a verified product identifier, associating the verified product identifier with the second segment, and after sending the first product information to the mobile device, sending second product information to the mobile device for display in association with the second segment, the second product information based on the verified product identifier.

The method may further include, after sending the first product information to the mobile device, generating a composite image in which both the first product information and the second product information are associated with the digital image received via the mobile device, and sending the second product information to the mobile device includes sending the composite image to the mobile device.

A method of analyzing images of physical items may include, at a mobile device with a camera, capturing, with the camera, a digital image of an array of products, and determining, in the digital image, a plurality of segments, each segment corresponding to a product in the array of products. The method may further include, for a segment of the plurality of segments, determining a candidate product identifier and determining a confidence value of the candidate product identifier. The method may further include, if the confidence value satisfies a condition, associating the candidate product identifier with the segment and displaying candidate product information in association with the segment, the candidate product information based on the candidate product identifier. The method may further include, if the confidence value fails to satisfy the condition, sending the segment to a remote device for manual image analysis.

The operation of determining the plurality of segments in the digital image may include analyzing the digital image using a first machine learning model trained using a corpus of first digital images, the operation of determining the candidate product identifier of the segment may include analyzing the segment using a second machine learning model trained using a corpus of second digital images, and the first machine learning model may be different than the second machine learning model.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts an example networked system.

FIG. 1B depicts an example image analysis engine.

FIG. 1C depicts an example workflow for analyzing images.

FIG. 1D depicts another example workflow for analyzing images.

FIG. 1E depicts another example workflow for analyzing images.

FIG. 2A depicts an example location selection interface of a workflow for capturing images for analysis.

FIG. 2B depicts an example image capture interface of the workflow.

FIG. 2C depicts an example image preview interface of the workflow.

FIG. 2D depicts an example dashboard interface of the workflow.

FIGS. 2E-2H depict an example data report interface of the workflow.

FIG. 2I depicts an example scene audit interface of the workflow.

FIG. 2J depicts an example item audit interface of the workflow.

FIG. 2K depicts an example barcode scanning interface of the workflow.

FIG. 2L depicts an example product information interface of the workflow.

FIG. 2M depicts another example product information interface of the workflow.

FIG. 2N depicts another example image preview interface of the workflow.

FIGS. 2O-2P depict example product information interfaces of the workflow.

FIGS. 3A-3B depict an example camera interface of the workflow.

FIGS. 4A-4C depict an additional example camera interface of the workflow.

FIG. 4D depicts an example composite image.

FIG. 5A depicts an example image segmenting interface of a workflow for generating training data.

FIGS. 5B-5C depict an example product associating interface of the workflow for generating training data.

FIG. 5D depicts an example product tag audit interface of the workflow for generating training data.

FIG. 5E depicts an example label set audit interface of the workflow for generating training data.

FIGS. 5F-5G depict an example interface for bulk tagging segments.

FIG. 5H depicts an example interface for reviewing mislabeled segments.

FIG. 5I depicts an example interface for reviewing a corpus of tagged segments.

FIG. 6 depicts an example flow chart of a process for recognizing products in images and associating product information with each of the recognized products.

FIG. 7 depicts an overhead view of a user capturing video in a store aisle.

FIGS. 8A-8C depict an example interface for capturing video of a product display.

FIGS. 8D-8G depict an example interface for capturing multiple images of a product display.

FIG. 9 depicts an example image generated from a captured video.

FIGS. 10A-10D depict aspects of a machine learning process.

FIG. 11 depicts an example flow chart of a process to produce compliance metrics for product displays.

FIG. 12 depicts an example interface for capturing images of a menu.

FIG. 13A depicts an example image of a menu after text items are identified.

FIG. 13B depicts an example image of a menu after text items are recognized.

FIG. 13C depicts a data structure of product information associated with a menu item.

FIG. 13D depicts an example interface for displaying results of a menu analysis.

FIG. 13E depicts an example interface for displaying information associated with a menu item.

FIG. 14 depicts an example flow chart of a process for associating product information with text items in a menu.

FIG. 15 depicts an example workflow for analyzing a menu with machine learning models.

FIG. 16 depicts a schematic diagram of an example electronic device.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to systems and methods for determining real-time compliance metrics and other scores for stores, restaurants, vendors, and other merchants. In particular, suppliers of products, such as food and beverages, may rely on merchants to sell their products to purchasers. Suppliers (which may include distributors associated with the suppliers) may enter agreements with merchants to have their products displayed in a particular manner or to stock a particular quantity of certain items. For example, a soda company may have an agreement that a certain number of rows in a refrigerated display case (e.g., a cold vault or cold box) will be stocked with a particular cola. Suppliers may also establish targets for its distributors or sales representatives. For example, a supplier may evaluate the performance of a sales representative based on the representative's ability to ensure that the particular cola is displayed in a certain number of rows in a refrigerated display case at a particular store. Other types of metrics may also be evaluated, such as the number of items on display in a display case, the location of particular items in a display case or on a shelf, the presence of brand names on a menu, or the like.

Evaluating whether or not a merchant or individual (e.g., distributor or sales representative) is in compliance with a particular target by human audits may be difficult and time consuming. In circumstances where an individual must visit multiple merchants in a day, spending time counting and recording the location of each item in a cold vault or cold box (including competitors' products) may present a serious burden on the individual and the supplier.

Described herein are systems and methods that facilitate a novel and unique automated workflow for determining real-time compliance metrics. For example, an individual who is visiting a store or merchant may capture an image (e.g., a photo and/or a video) of a display of products. The image may be sent to a remote server and analyzed using a computer-implemented automated image analysis and/or item recognition operation to determine what items are present in the display. Returning to the example of a refrigerated display case, the image analysis operation may determine what product is in each row of the display case (e.g., in the front-most position of each row) and the overall arrangement of products within the refrigerated display case. The automated image analysis operation may include multiple steps or operations to determine which areas of the image depict products and to determine what the products are. Once an image is processed to identify each product in the image, the system may perform additional analyses to determine metrics such as how many rows contain a particular product, how many different products are present in the image, the location of each product, whether the products are grouped together, or the like. The system may compare these metrics against targets to determine compliance scores and particular action items that need to be taken to achieve a particular target. For example, a store may be associated with a target of ten rows of a particular cola in a display case, and the image may show that the display case has only six rows of the cola. The system may thus determine that the store is out of compliance (e.g., too few rows of the display case contain the cola), and may determine that adding four rows of cola may bring the store into compliance. More complex compliance scores and action items may be provided in cases where there are multiple targets for multiple different products. Further, even where compliance scores are not provided, raw data may be provided to the interested parties (e.g., what percentage of a display case is occupied by a particular company's products).

These metrics, including compliance scores and action items, may be returned to the individual who captured the image while the individual is on site at the store. In some cases, due to the automatic image processing, the metrics may be returned to the user within minutes (or less) after the image is captured. This may increase efficiency for users of the system, as an individual can both capture the product data and perform the action items (to improve the compliance scores) in the same visit, rather than having to capture the product data and perform action items across multiple visits, sometimes after the product data becomes stale or is no longer accurate.

The system described herein may maintain a record log or other non-transitory storage of multiple visits to a particular store or location. The record log may include the images taken at each visit, metrics extracted from the images, and respective compliance scores or other data analysis performed that is associated with a particular visit. The system can then track compliance and/or other performance criteria associated with a store or location over time and provide further analytics to the vendor or distributor. Similarly, the system may aggregate data across multiple stores that are associated with a particular retailer in order to provide aggregated compliance and/or performance data (and/or provide results of any individual image, visit, display case, or the like).

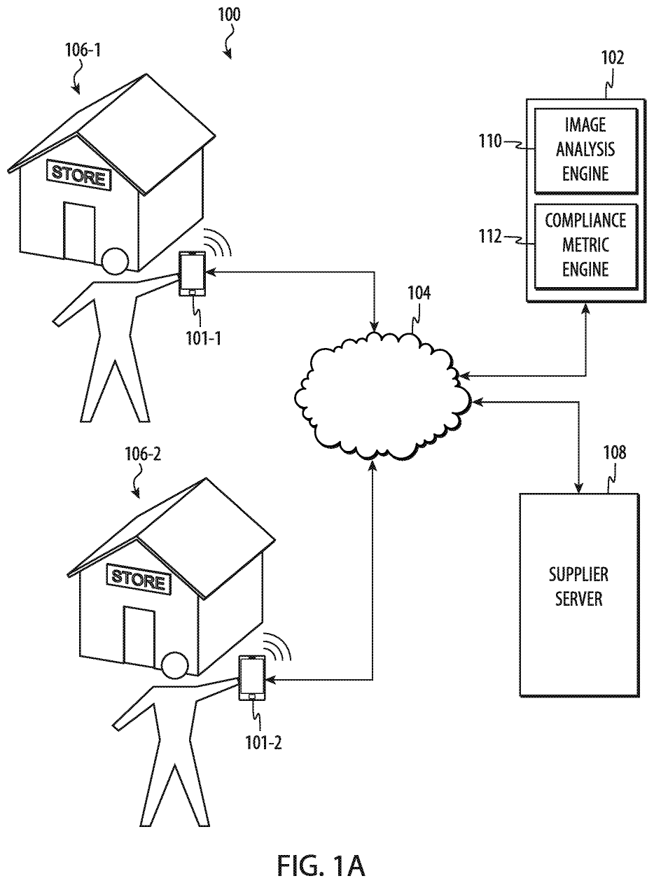

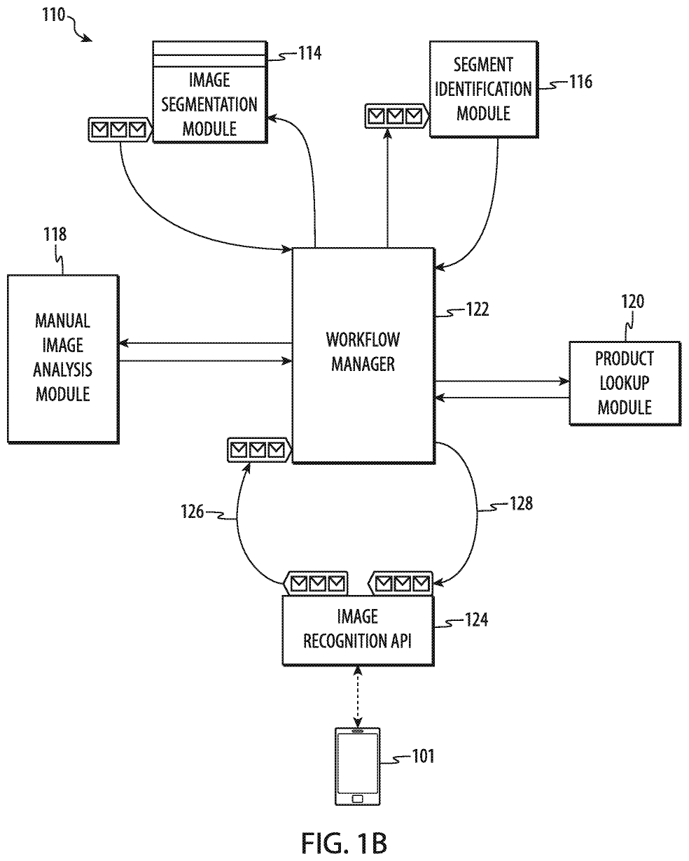

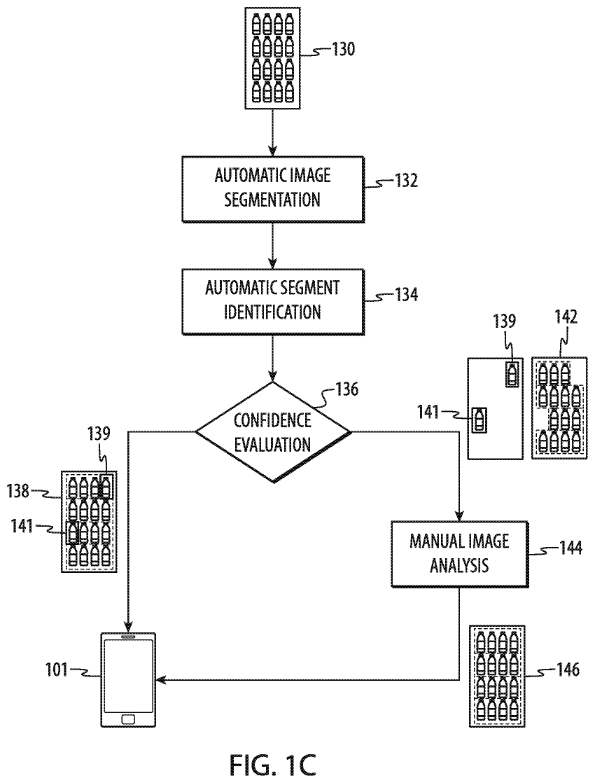

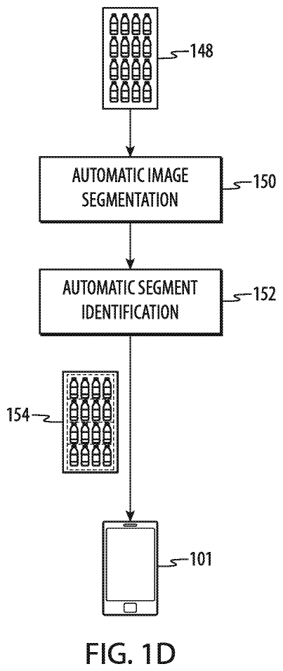

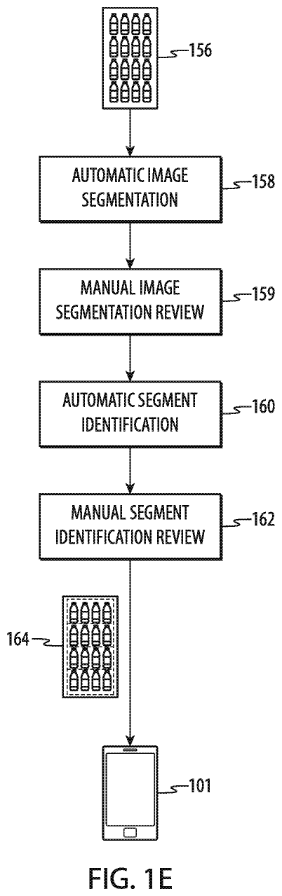

The process of obtaining images of products, associating the images with a particular location (e.g., a retail store), sending the images for analysis, receiving an annotated image, receiving compliance scores (or other data) and action items, and performing real-time updates and corrections to the annotated image may all be facilitated by an application that may be executed on a portable computing device, such as a mobile phone, tablet computer, laptop computer, personal digital assistant, or the like. The application may facilitate the capture of the relevant product information and may provide real-time (e.g., less than about three minutes) compliance scores and action items. Operations such as analyzing images, recognizing objects or products in images, managing image analysis operations, and the like, may be performed by other components of the system, including servers, databases, workflow managers, and the like. FIGS. 1A-1B illustrate further details of the systems, modules, and operations of an image analysis and/or item recognition system 110 (referred to herein simply as an image analysis engine 110) that performs and/or facilitates the operations described herein. As used herein, a “module” may include computer hardware that that has been adapted by software, firmware, or other computer code in order to facilitate the execution and/or performance of the operations described with reference to the module. For example, a module may include one or more computers (e.g., server computers, desktop computers, mobile devices, etc.), image acquisition hardware, location determining hardware, accelerometers, magnetometers, gyros and other orientation determining hardware, and/or software for performing operations associated with the module and/or for generating user interfaces to facilitate use of the module, user input devices (e.g., keyboards, touchscreens, display screens, pointing devices), and the like.

FIG. 1A depicts an example networked system 100 in which the present processes and techniques may be used. The networked system 100 includes one or more users each associated with a device 101. The device(s) 101 (also referred to herein as client devices 101) may be any suitable device, such as a mobile phone, tablet computer, laptop computer, or the like. The device(s) 101 may include integrated cameras, processors, displays, and the like, and may include communication hardware to facilitate communication, through a network 104, with other computers or devices. The network 104 may be any suitable communications network, such as the internet, a wide area network, a cellular network, direct point-to-point communications, or the like.

The one or more users may use the device(s) 101 at sales locations 106 to capture images of product displays at those locations. The sales locations 106 may be any suitable store, vendor, vending machine, outlet, or other location where products and/or goods are sold.

The networked system 100 also includes one or more remote servers 102. The remote server(s) 102 may be associated with a product supplier or an analytics service that provides image analysis and/or compliance metrics for products supplied by a product supplier (e.g., food, beverage, or other goods). In some cases, the remote server(s) 102 may include or use an image analysis engine 110, as described herein, to automatically (and/or manually) analyze images, recognize items (and/or text) in the images, and associate product identifiers and/or product information with the items (and/or text) in the images. The image analysis engine 110 may analyze images of many different types of objects or scenes. For example, the image analysis engine 110 may analyze images of cold vaults, cold boxes, refrigerated display cases, store aisles, menus, or the like.

In some cases, the remote server(s) 102 may include or use a compliance metric engine 112, as described herein, to automatically determine a compliance metric of a display of products. The image analysis engine 110 and the compliance metric engine 112 may use machine learning models that are generated using a corpus of training data that is appropriate for that particular application. For example, the training data used to generate the machine learning model(s) of the image analysis engine 110 may include photographs of items, each associated with a product identifier or product information that identifies the product in the photograph. The training data used to train the machine learning model(s) of the compliance metric engine 112 may include item matrices, each associated with a compliance score representing, in one example, a degree of conformance to a planogram or other target display arrangement. The machine learning model(s) used by the image analysis engine 110 and/or the compliance metric engine 112 may use any suitable algorithms, formulas, mathematical constructs, or the like, to produce the desired outputs (e.g., a list of items recognized in an image and compliance metrics, respectively). For example, machine learning models for these engines, and indeed any other machine learning techniques described herein, may be based on, use, contain, be generated using, or otherwise be implemented using artificial neural networks, support vector machines, Bayesian networks, genetic algorithms, or the like. Machine learning algorithms and/or models described herein may be implemented using any suitable software, toolset, program, or the like, including but not limited to Google Prediction API, NeuroSolutions, TensorFlow, Apache Mahout, PyTorch, or Deeplearning4j. As used herein, a machine learning model may be referred to as an ML model, a trained product model, or simply a model.

The remote server(s) 102 may receive data from the device(s) 101, such as images of product displays captured by the device(s) 101. The remote server(s) 102 may also send data to the device(s) 101, such as annotated images and/or data sets that include product information associated with the products depicted in the image. The remote server(s) 102 may communicate with the supplier server 108 (described below). The remote server(s) 102 may also determine compliance metrics based on the annotated images (or the data files or data sets) that may be returned to the device(s) 101 and/or the supplier server 108.

The networked system may further include a supplier server 108. The supplier server 108 may be associated with a supplier of products (e.g., food, beverages, or other goods). The supplier server 108 may send information to the remote server(s) 102. For example, the supplier server 108 may send to the remote server(s) 102 compliance targets, planograms, product lists, and the like. Compliance targets may include, for example, data about how many products they want displayed at particular sales locations 106, what types of products they want displayed, where they want products displayed, or the like. The supplier server 108 may also receive compliance metrics, analytic results or other similar types of results or performance indicia from the remote server(s) 102 and/or the mobile devices 101.

FIG. 1B illustrates an example implementation of the image analysis engine 110. The image analysis engine 110 may be or may include one or more computers, such as server computers, desktop computers, or the like, that perform the operations described with respect to the image analysis engine 110.

As described herein, the image analysis engine 110 is configured to receive images of displays, shelves, aisles, menus, or other objects or scenes of interest, and subject the images to one or more workflows. The particular workflows to which an image is subjected may depend on various factors, such as the type of scene or object in the image, the confidence with which the image analysis engine 110 can automatically determine the contents of the image, the type of analysis requested by a customer, or the like. Various example workflows are described herein.

The image analysis engine 110 includes an image segmentation module 114, a segment identification module 116, a manual image analysis module 118, and a product lookup module 120. The image analysis engine 110 also includes a workflow manager 122 that receives images from other sources, such as a mobile device 101, manages the routing of images and other data through the image analysis engine 110, and provides analyzed images and associated data to other sources, such as the mobile device 101, the compliance metric engine 112, the supplier server 108, or the like.

The image segmentation module 114 may be configured to automatically detect or determine segments of images that correspond to or contain the individual physical items. For example, the image segmentation module 114 may receive an image of a cold vault and identify individual areas in the image that contain beverage bottles. As another example, the image segmentation module 114 may receive an image of a restaurant menu and identify individual areas on the menu that correspond to beverages. The areas within an image that are identified by the image segmentation module 114 may be referred to herein as segments.

The image segmentation module 114 may use machine learning models to automatically determine the segments in an image. For example, one or more machine learning models may be trained using a corpus of previously identified segments. More particularly, the corpus may include a plurality of images, with each image having been previously segmented. The corpus may be produced by human operators reviewing images and manually defining segments in the images. In some cases, results of the machine learning model(s) that have been confirmed to be correct (e.g., segments confirmed by a human operator to have been accurately positioned in an image) may be used to periodically (or continuously) retrain the model(s).

The image segmentation module 114 may provide the segmented image to the workflow manager 122. The segmented image may be provided in any suitable manner or format. For example, it may be provided as an image with associated metadata that defines the location and/or size of each segment.

The segment identification module 116 may receive segmented images (and/or individual segments) from the image segmentation module 114, from the manual image analysis module 118, or from another source. The segment identification module 116 may automatically identify the contents of a segment. More particularly, a unique product identifier (e.g., a UPC) of the product in the segment may be automatically associated with the segment. For example, if the image is a segmented image of a cold vault, the segment identification module 116 may determine (or attempt to determine) the identity of the beverage in each segment. If the image is a segmented image of a menu, the segment identification module 116 may determine (or attempt to determine) the particular ingredients of a drink in the menu. As used herein, segment identification may also be referred to as product identification, because the operation ultimately identifies what product is within a segment (e.g., a product identifier is associated with the product depicted in the segment).

The segment identification module 116 may use machine learning models to identify the contents of a segment. For example, one or more machine learning models may be trained using a corpus of segments whose contents have been previously identified and labeled. The corpus may be produced by human operators reviewing segments and manually identifying the contents of the segments. In some cases, results of the machine learning model(s) that have been confirmed to be correct (e.g., segments whose contents were confirmed by a human operator to have been accurately identified) may be used to periodically (or continuously) retrain the model(s).

The segment identification module 116 may provide the identified segments (e.g., segments that have been associated with product identifiers) to the workflow manager 122. The identified segments may be provided in any suitable manner or format. For example, the segment identification module 116 may provide the segmented image along with associated metadata that identifies the contents of each of the segments (assuming the segments were able to be identified by the segment identification module 116). The segment identification module 116 may also provide a confidence metric of the identification of the contents of the segments. The confidence metric may be based on a label confidence output by the machine learning model(s) used by the segment identification module 116, and may be used by the workflow manager 122 to determine the next operations in the workflow for that particular image or segment. The confidence metric may indicate a relative confidence that the contents of the segment have been correctly identified by the segment identification module 116.

The corpus with which the machine learning models of the segment identification module 116 are trained may include segments that are labeled with or otherwise associated with a product identifier, such as a universal product code (UPC), a stockkeeping unit (SKU), or other product identifier. Accordingly, the output of the segment identification module 116 may be segments that are associated with UPCs, SKUs, or the like. Such coded information may not be particularly useful to human operators, however, as UPCs or SKUs do not convey useful human-understandable product information (e.g., the name of a beverage). In order to provide more useful information, the product lookup module 120 may store product information in association with product identifiers. When providing results to users or other individuals, the image analysis engine 110 may use the product lookup module 120 to associate relevant product information (e.g., a beverage brand, type, size, etc.) with a segment. The product lookup module 120 may use UPCs, SKUs, or another product identifier as the search key to locate the relevant product information.

The image analysis engine 110 may also include a manual image analysis module 118. The manual image analysis module 118 may provide programs, applications, user interfaces, and the like, that facilitate manual, human image analysis operations. For example, the image analysis engine 110 may allow human operators to segment images (e.g., determine the areas in an image that contain items of interest) and identify the contents of segments (e.g., associate UPCs with individual segments). Results of the manual image analysis module 118 may be used to train the machine learning models used by the image segmentation module 114 and/or the segment identification module 116.

The manual image analysis module 118 may also audit or review results of the image segmentation module 114 and/or the segment identification module 116. For example, if a confidence metric of a segmentation or segment identification is below a threshold, that segment may be provided to the manual image analysis module 118 for human operator review. In some cases, images that are to be analyzed by the manual image analysis module 118 may be first processed by the image segmentation module 114 and/or the segment identification module 116 in order to provide to the human operator an automatically-generated suggestion of a segmentation or segment identification.

The workflow manager 122 may be responsible for routing images, segments, and other information and data through the image analysis engine 110. The particular workflow for a given image may depend on various factors. For example, different customers may request different types of image analysis, thus resulting in the workflow manager 122 routing the images for those customers through the image analysis engine 110 in a different manner. More particularly, one customer may want only automated segmentation and segment identification, even if that means that there is no human audit to find and correct possible errors in the results. In that case, the workflow manager 122 may route images to the image segmentation module 114 and the segment identification module 116, but not to the manual image analysis module 118. On the other hand, another customer may require that all images be manually analyzed. In that case, the workflow manager 122 may route all images to the manual image analysis module 118 (in some cases after they have been initially analyzed by the image segmentation module 114 and/or the segment identification module 116).

The workflow manager 122 may determine different workflows for images based on the results of certain operations within the image analysis engine 110. For example, as described herein, the workflow manager 122 may route images (or segments of images) to different modules depending, in part, on the confidence with which the automated analysis processes are performed.

The workflow manager 122 may manage the routing of images or other data through the image analysis engine 110 using message queues. For example, image analysis tasks may be issued to the workflow manager 122 via an image recognition application program interface (API) 124. The image recognition API 124 may receive image analysis tasks 126 from multiple client devices (e.g., the device 101). The image analysis tasks 126 may be received in a message queue of the workflow manager 122. The workflow manager 122 may then issue tasks to the other modules by issues tasks to the respective message queues of those modules (e.g., the image segmentation module 114, the segment identification module 116, the manual image analysis module 118, and/or the product lookup module 120). As noted above, the particular tasks that the workflow manager 122 issues in response to receiving an image analysis task 126 may depend on various factors, and are not necessarily the same for every image analysis task 126.

When the modules complete a task from their message queues, they return results to the workflow manager 122, which then takes appropriate action in response to receiving the results. For example, the workflow manager 122 may send an image, via a task request, to the message queue of the image segmentation module 114. When the segmentation is complete (e.g., after the segments in the image have been determined), the workflow manager 122 may receive a segmented image from the image segmentation module 114 (e.g., a segmented image), and then issue a task, along with the segmented image, to the message queue of the segment identification module 116. When the segment identification is complete, the segment identification module 116 may return the segmented image, along with an associated product identifier or other product information and confidence metrics, to the workflow manager 122. The workflow manager 122 may then determine how to further route the image based on these results. Ultimately, the workflow manager 122 may provide results 128 (e.g., a fully analyzed image with associated product information) to the image recognition API 124. The image recognition API 124 may cause the results to be transmitted to the client device 101, or another device or system (e.g., a database, a supplier server, or the like).

The operations performed by the image analysis engine 110, and the networked system 100 more generally, including automatic image analysis and intelligent routing of requests from numerous different devices and for numerous different purposes, are complex and computationally intensive. Indeed, some of these operations may be difficult to perform on mobile devices alone. However, the use of mobile devices to capture images and other data in real-time (and to report data to the user while they are in the field) may be necessary to achieve the effective scale of deployment. Accordingly, the systems and methods described herein provide a centralized service comprised of one or more modules, as described herein, that can receive information from numerous distributed mobile devices and intelligently and dynamically route the received information through an image analysis system to provide fast and accurate analytics back to the users in the field (or other interested parties). Accordingly, the mobile devices may be relieved of computationally intensive operations, and data can be consolidated and served more efficiently. Because the complex image analysis and data routing is performed centrally, the software that is required to be executed on the mobile devices may be less complex that it would be if local image processing were used, thus reducing the complexity of creating and maintaining complex software for numerous different types of mobile devices. Also, because product data is stored and accessed centrally (e.g., by the remote server), the system is highly scalable, as updates to product databases, UPC codes, and the like, can be applied to the central system, rather than being sent to and stored on the multitudes of mobile devices that may be used in the instant system.

As noted above, the workflow manager 122 may implement different workflows for different tasks. For example, some workflows provide for manual image analysis, while others provide for fully automatic image analysis (e.g., with no human supervision or intervention). Other workflows include a combination of human and manual image analysis. FIGS. 1C-1E depict example workflows that may be implemented by the workflow manager 122 and performed, more generally, by the image analysis engine 110.

FIG. 1C illustrates a workflow in which automatic image analysis is used to provide image analysis results quickly (e.g., less than about three minutes), and manual image analysis is used to supplement the automatic image analysis (with results taking potentially longer to supply to a client). This may be particularly attractive to suppliers or other users of the system because it provides an advantageous balance of speed and accuracy. More particularly, the use of the automatic image analysis processes provides rapid results to the user for any and all segments of an image that can be confidently identified by the machine learning models of the automatic image analysis modules (e.g., the image segmentation module 114 and the segment identification module 116). For segments that cannot be confidently identified, however, providing inaccurate results to the users may not be helpful and may in fact be misleading. Accordingly, the workflow shown in FIG. 1C holds back those segments that were not able to be automatically identified (or were identified with only a low confidence) so that they can be manually analyzed and so that only accurate results are provided to the user. Once the manual image analysis is complete, the image analysis engine 110 may then aggregate both the automatically identified segments and the manually identified segments to provide a completely and accurately analyzed image.

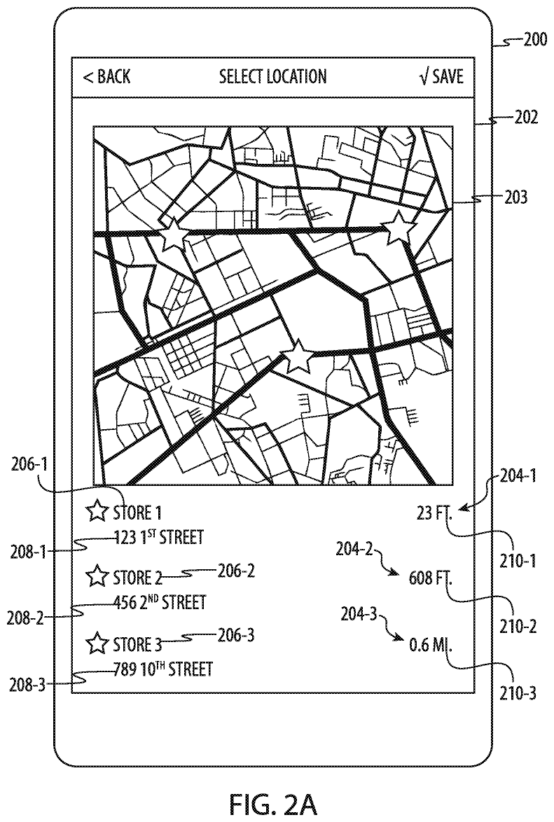

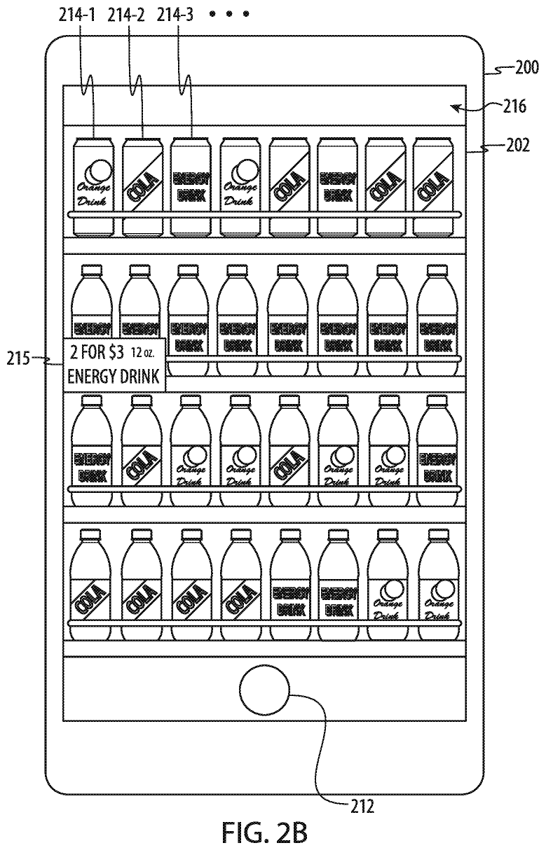

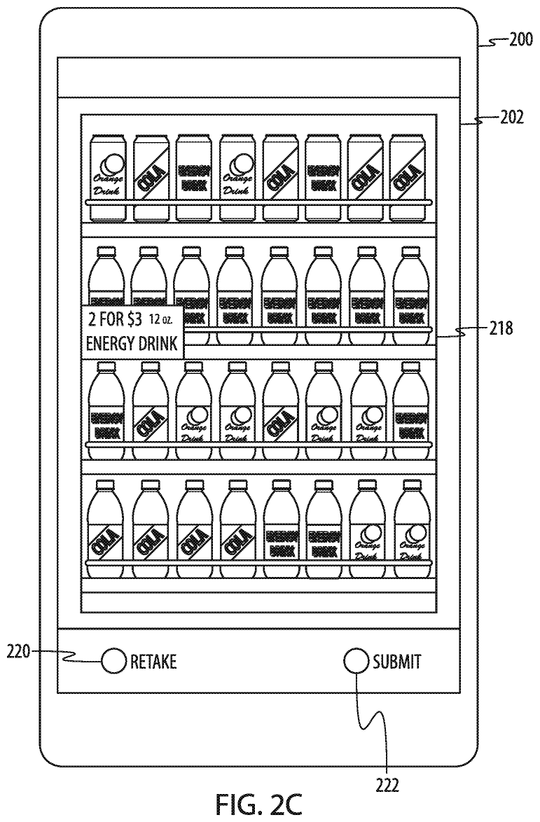

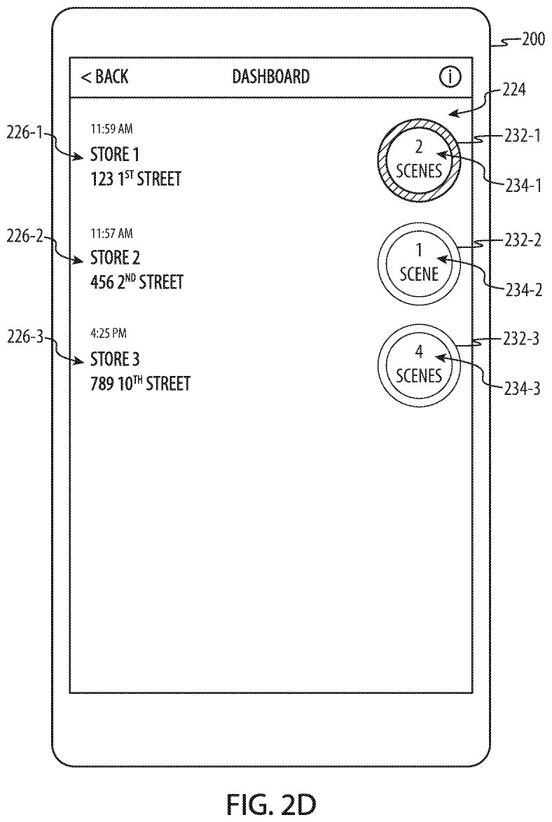

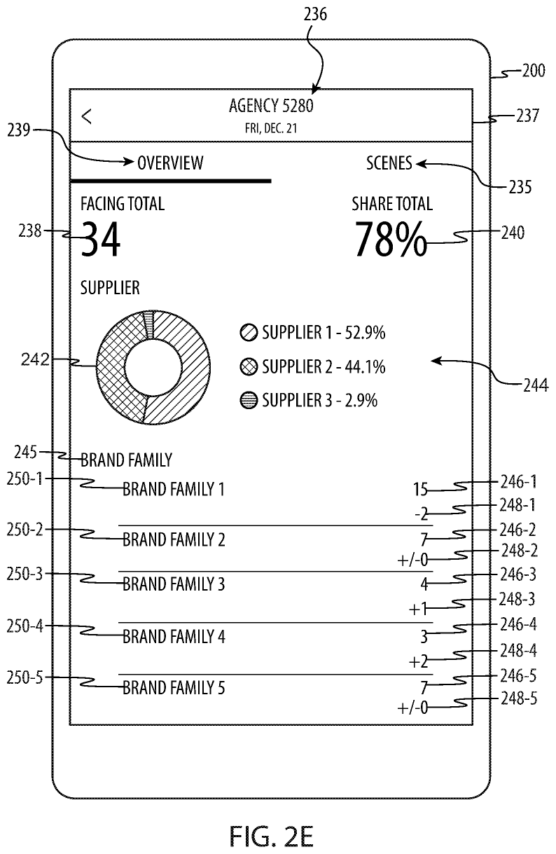

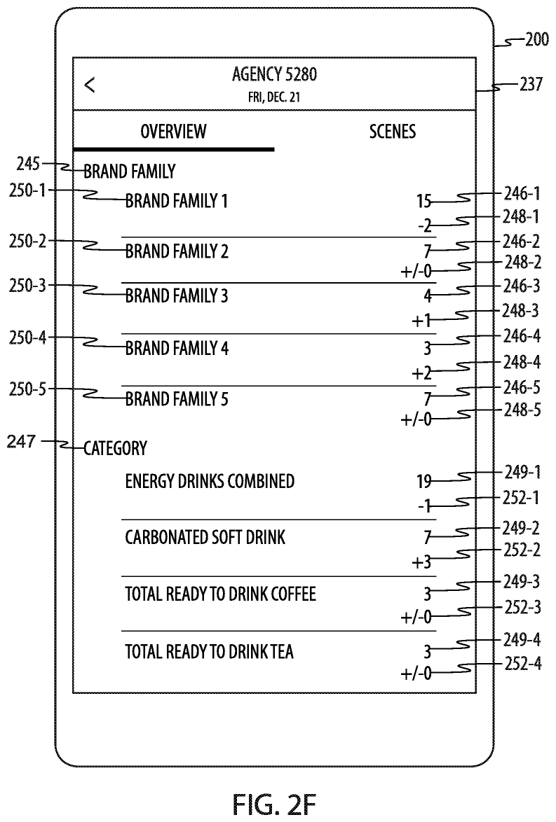

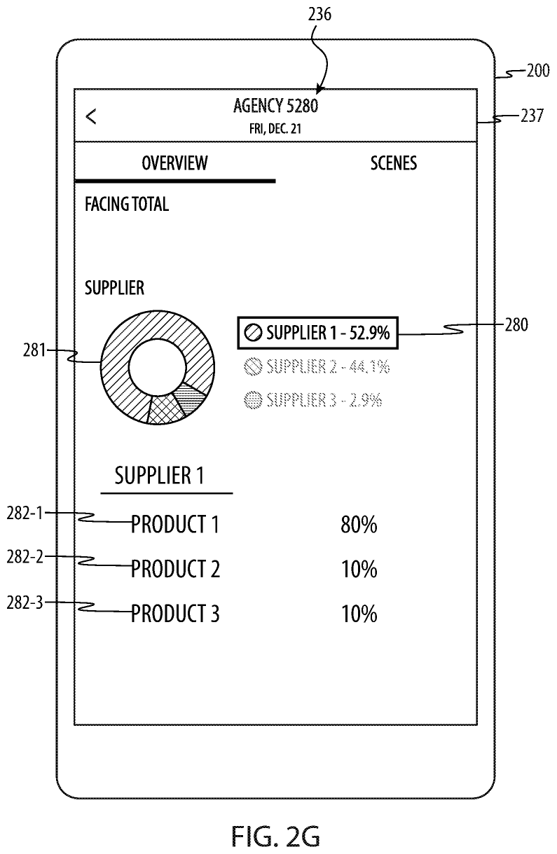

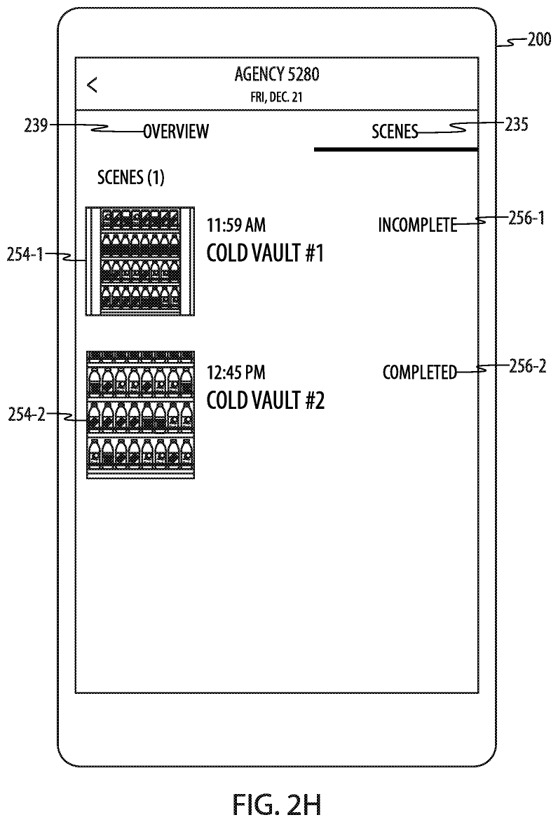

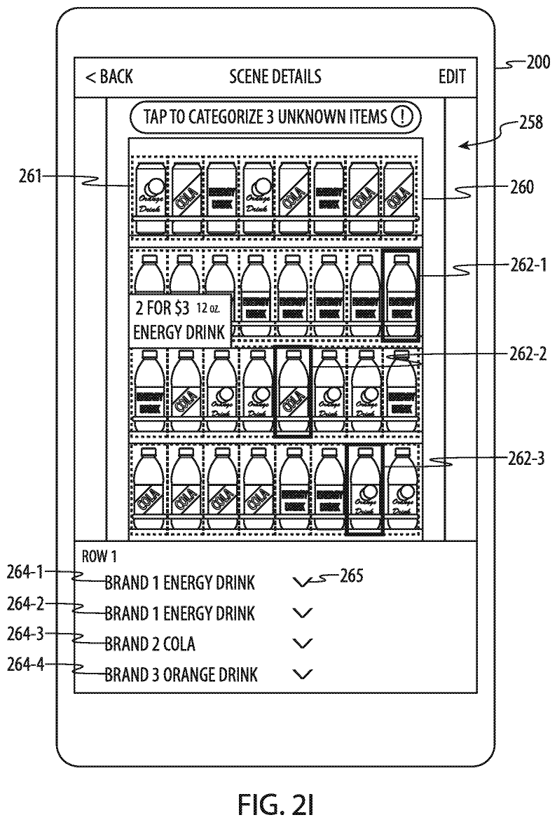

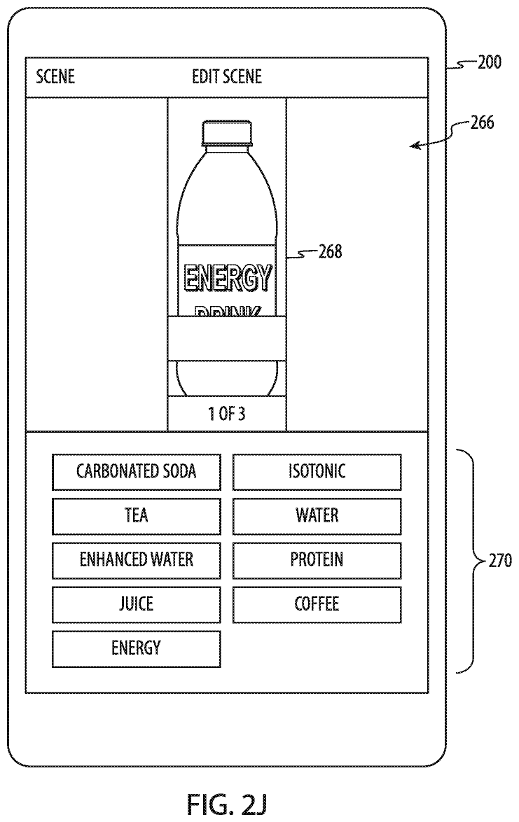

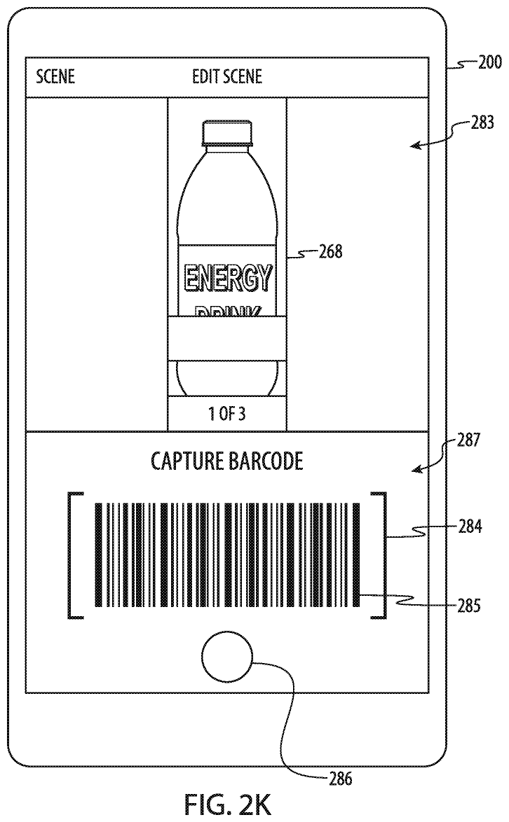

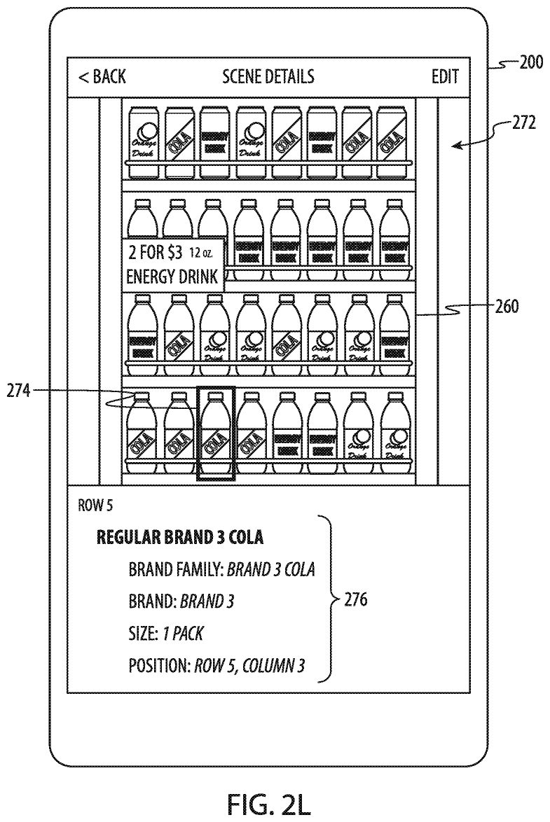

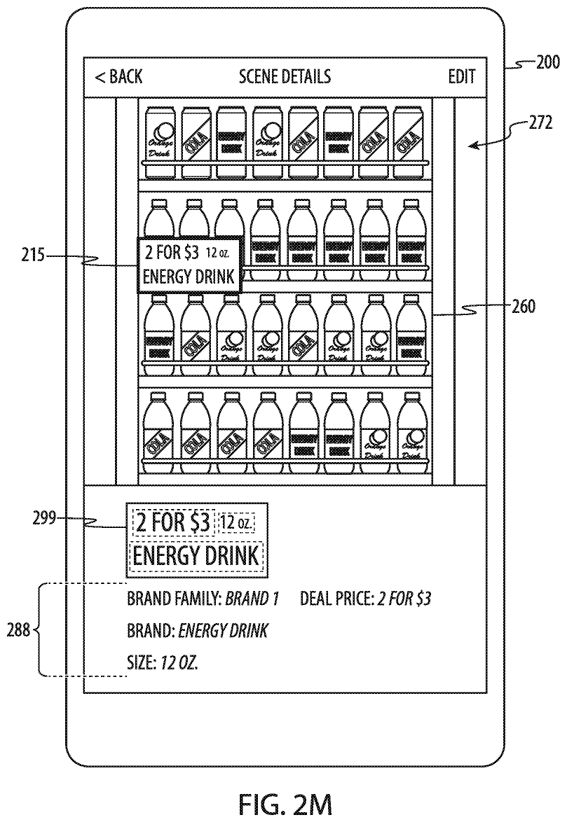

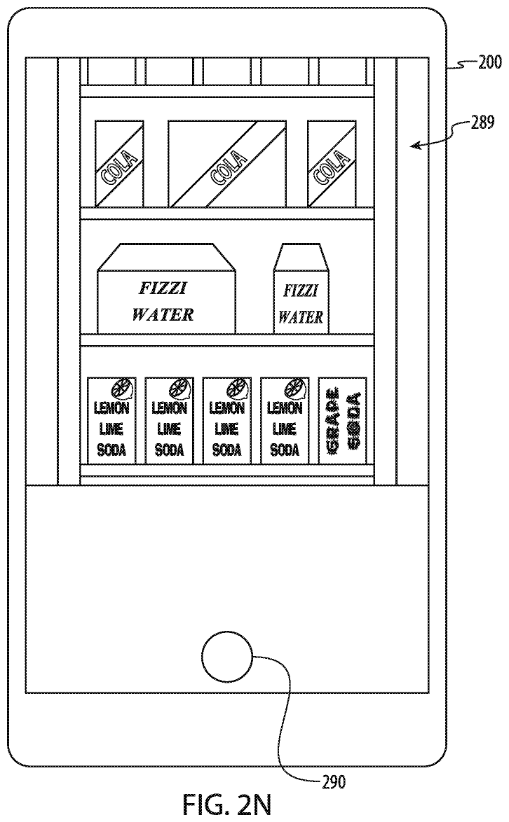

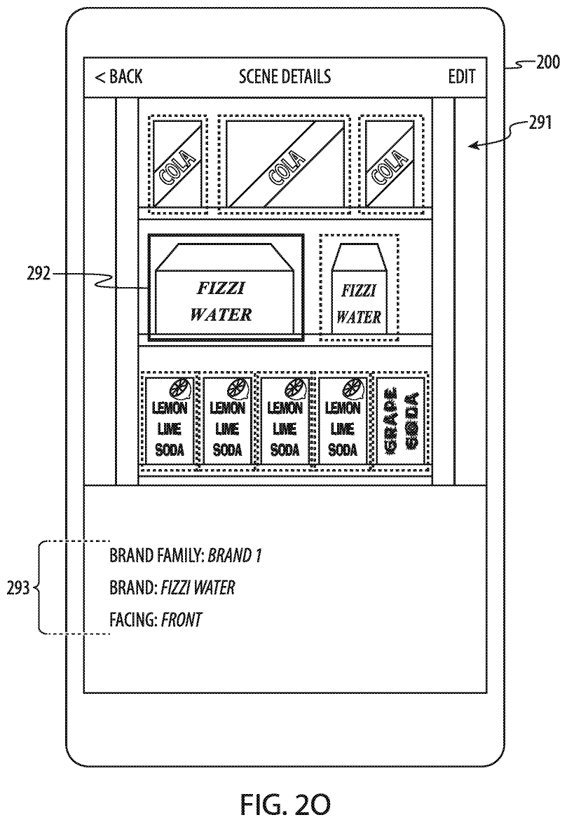

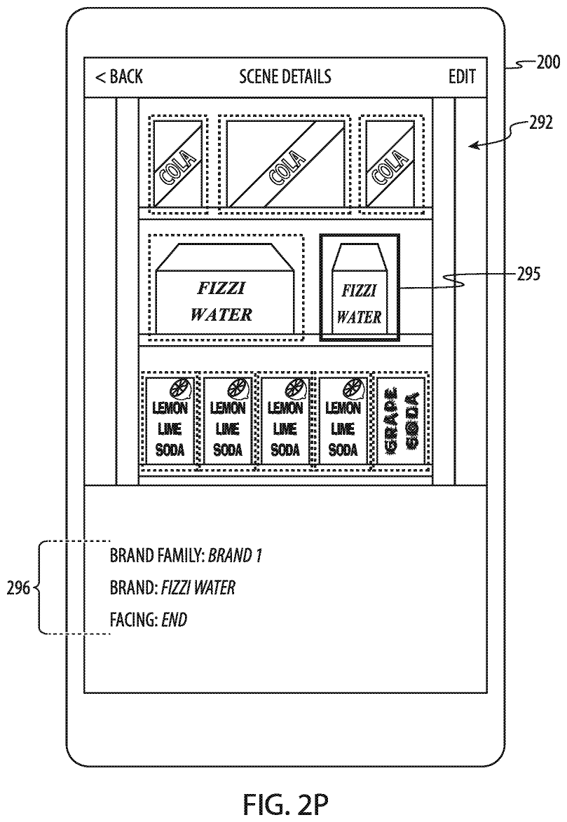

Returning to FIG. 1C, an image 130 is provided to the image analysis engine 110. The image 130 may be captured by a client device, such as the device 101, while the client device is in the field at a customer location. The image 130 may be an image of a product display such as a cold vault, cold box, aisle, display shelf, menu, or the like. The image 130 may be sent to the image analysis engine 110 so that it can be analyzed to determine information such as the products in the image, the locations of the products, the relative amounts of products provided by different suppliers, or the like. Further examples of image capture operations and example images are described herein with respect to FIGS. 2B-2C, 2N, 3A-4B, and 7-8G.

When the image 130 is received by the image analysis engine 110, the workflow manager 122 may route the image through an automatic image analysis workflow so that results can be rapidly provided to the client device (or to any device that has been selected to receive image analysis results). This may include providing the image 130 to the image segmentation module 114 to initiate an automatic image segmentation operation 132. More particularly, the workflow manager 122 may issue a task, which includes the image 130, to the message queue of the image segmentation module 114.

Once the automatic image segmentation operation 132 is complete (e.g., once the image segmentation operation has determined segments in the image), the segmented image may be returned to the workflow manager 122. The workflow manager 122 then provides the segmented image to the segment identification module 116 to initiate an automatic segment identification operation 134 (also referred to as product identification). This may include issuing a task, which includes the segmented image, to the message queue of the segment identification module 116.

Once the automatic segment identification operation 134 is complete, the image with the identified segments may be returned to the workflow manager 122. As noted above, however, the segment identification module 116 may not be able to identify the contents of each and every segment in the segmented image with a high confidence. Rather, in some cases, some of the segments' contents will be identified with a high degree of confidence (e.g., 90% or above), while others may be identified with a low degree of confidence (e.g., 50% or below). The workflow manager 122 may therefore determine which segments have sufficient confidence metrics to be provided immediately to a user, and which require further analysis or review.

At operation 136, the workflow manager 122 evaluates the automatically identified segments and determines which are to be submitted as immediate results to the user, and which are to be further analyzed. For example, the workflow manager 122 may determine which identified segments have a confidence metric that satisfies a confidence condition. The confidence condition may be any suitable condition, such as a threshold confidence metric. For example, the confidence condition for a segment may be deemed satisfied if the confidence metric for that segment is greater than or equal to about 90%, about 95%, about 97%, about 99%, or any other suitable value. The particular threshold value that is selected may be established by the particular client or customer who is requesting the information, as some clients may be more willing to accept errors so that they can get the results more quickly, while others may prefer accuracy over speed.

Image 138 represents an example image that includes a subset of segments whose confidence metrics satisfy the confidence condition (shown in dotted boxes), as well as a subset of segments whose confidence metrics fail to satisfy the confidence condition (e.g., segments 139, 141 shown in solid boxes). The workflow manager 122 may provide the partially analyzed image 138 to the client device 101 (or to another device or storage system preferred by a client or customer). The image 138 may graphically or otherwise indicate that some of the segments have not been successfully identified. In some cases, the low-confidence identification is provided with the image 138 so that the user has an idea of what those segments may contain. In other cases, no identification is provided.

In addition to providing the partially analyzed image 138 to the client device 101, the workflow manager 122 may provide the low-confidence segments 139, 141 to the manual image analysis module 118 to initiate a manual segment identification operation 144. This may include issuing a task, which includes the low-confidence segments 139, 141 (and optionally the high-confidence segments 142), to the message queue of the segment identification module 116. In the manual image analysis operation, one or more human operators may visually review the low-confidence segments 139, 141, identify the contents of those segments, and associate those segments with product identifiers (e.g., UPC codes).

Once the contents of the low-confidence segments 139, 141 have been identified at operation 144, the now-identified segments 139, 141 may be returned to the workflow manager 122. The workflow manager 122 may compile or combine the now-identified segments 139, 141 with the high-confidence segments 142 to produce a composite image 146. The composite image 146 thus includes segments that were automatically identified (e.g., by the image segmentation and segment identification modules, using machine learning models), as well as segments that were manually identified. The composite image 146 may be delivered to the client device 101 after it has been prepared, or it may be delivered to another device or system, or otherwise made available for access by relevant parties.

FIG. 1C describes a process in which the workflow manager 122 performs operations on individual segments, as compared to processes in which the entire images are processed together (and results are only provided when all segments in the image are fully and accurately identified). This allows for faster, more dynamic delivery of analysis results, and can reduce both computer and human workloads as compared to operations where entire images are analyzed as a whole.

In some cases, instead of or in addition to performing automatic image analysis operations (e.g., operations 132, 134) on the image analysis engine 110, these operations may be performed on the device that captured the images. For example, the machine learning models used by the image segmentation module 114 and/or the segment identification module 116 (or models derived from, similar to, or configured to produce similar results) may be executed by the device 101 after capturing the image. Segment identification results from on-device analysis may then be provided to the user, while segments whose confidence metrics do not satisfy a condition may be processed according to the manual image analysis process described with respect to FIG. 1C. For example, segments whose confidence metrics do not satisfy a condition may be sent to a remote server (e.g., the remote server 102) for further analysis.

FIG. 1D illustrates a workflow in which images are exclusively analyzed using automatic image analysis processes. This workflow may be capable of producing fast image analysis results by omitting manual image analysis tasks for segments that do not satisfy a confidence condition. Rather, the segments that do not satisfy a confidence condition may be omitted from the ultimate image analysis results that are delivered to the client, or they may be provided with a warning or other indication of the low confidence metric of the identification.

Upon receiving an image 148 (e.g., from a client device 101 via the image recognition API 124), the workflow manager 122 may route the image 148 through an automatic image analysis workflow. This may include providing the image 148 to the image segmentation module 114 to initiate an automatic image segmentation operation 150. More particularly, the workflow manager 122 may issue a task, which includes the image 148, to the message queue of the image segmentation module 114.

Once the automatic image segmentation operation 150 is complete (e.g., when the segments in the image have been determined), the segmented image may be returned to the workflow manager 122. The workflow manager 122 then provides the segmented image to the segment identification module 116 to initiate an automatic segment identification operation 152. This may include issuing a task, which includes the segmented image, to the message queue of the segment identification module 116.

Once the automatic segment identification operation 152 is complete, the image with the identified segments may be returned to the workflow manager 122, which may provide the segmented and identified image 154 to the client device 101. As noted above, the segmented and identified image 154 may never be reviewed or audited by a human operator. Further, the segmented and identified image 154 may include only segment identifications that satisfy a confidence condition, or it may include all segment identifications regardless of their confidence metrics.

FIG. 1E illustrates a workflow in which images are fully audited by a manual image analysis before the analyzed images are returned to a client. This workflow may be capable of producing highly accurate image analysis results, but may be slower than other techniques that deliver at least some automatically identified image segments without prior human audit.

Upon receiving an image 156 (e.g., from a client device 101 via the image recognition API 124), the workflow manager 122 may route the image 156 through an automatic image analysis workflow. This may include providing the image 156 to the image segmentation module 114 to initiate an automatic image segmentation operation 158. More particularly, the workflow manager 122 may issue a task, which includes the image 156, to the message queue of the image segmentation module 114.

Once the automatic image segmentation operation 158 is complete, the segmented image may be returned to the workflow manager 122. The workflow manager 122 then provides the segmented image to the manual image analysis module 118 for manual image segmentation review at operation 159. This may include issuing a task, which includes the segmented image, to the message queue of the manual image analysis module 118. The manual image segmentation review operation may include a human operator reviewing each image to confirm that the segmentation (e.g., the location, size, shape, etc.) of the segments are correct, and optionally that each segment contains an object of interest (e.g., a beverage container or other consumer product). The human operator may also correct any segmentation errors, such as by changing the location, size, shape, etc., of the automatically identified segments, deleting or removing segments, adding or identifying new segments, or the like.

Once the manual image segmentation review operation is complete, the now-reviewed segmented image may be returned to the workflow manager 122, which then provides the segmented image to the segment identification module 116 to initiate an automatic segment identification operation 160. As noted above, in the automatic segment identification operation 160, machine learning models may determine a particular UPC (or other product identifier) that corresponds to the product in the segment.

Once the automatic segment identification operation 160 is complete, the image with the identified segments may be returned to the workflow manager 122. The workflow manager 122 may then provide the image to the manual image analysis module 118 for manual segment identification review at operation 162. The manual segment identification review operation may include a human operator reviewing and identifying the contents of any segments whose confidence metrics do not satisfy a confidence condition, and optionally reviewing and confirming that the contents of all segments have been correctly identified by the automatic image analysis operations. Once the manual image analysis operation 162 is complete, the image with the identified segments may be returned to the workflow manager 122, which may provide the segmented and identified image 164 to the client device 101.

In the foregoing discussions with respect to FIGS. 1A-1E, it will be understood that the term “image” need not refer to any particular file type, nor is it limited to only visual or graphical information. Rather, an image may refer to information that includes visual or graphical components as well as auxiliary information such as product information, segment size, shape, and location information, and the like. In some cases, visual or graphical components may be stored in a separate computer readable file or other data structure than the auxiliary information.

FIGS. 2A-2P depict an example workflow for determining real-time compliance metrics and other scores for stores, restaurants, vendors, and other merchants. The workflow defines a series of operations that are performed on and/or in conjunction with a mobile electronic device 200 (referred to herein simply as a “device 200”), such as a tablet computer, mobile phone, or the like. As shown in FIGS. 2A-2P, user interfaces associated with various workflow operations are displayed on a display 202 of a mobile phone, though it will be understood that the device 200 may correspond to other devices as well.

FIG. 2A depicts an example interface corresponding to a location selection operation. In this operation, an individual is prompted to enter or select a location, such as from a list of candidate locations. Locations may correspond to a store, restaurant, or other establishment where a supplier's products are sold or available. Once selected, the data that is captured during the workflow, as well as any compliance scores, action items, or other product or compliance data or information (which may be referred to collectively as workflow data), may be associated with the selected location. A time stamp (e.g., a date and time) may be associated with the workflow data in addition to the location. Accordingly, the results of each workflow (e.g., product data and compliance information) may be associated with a particular visit to a particular location. Candidate locations 204 (e.g., 204-1, . . . , 204-n) may be presented in a list and indicated on a map 203.

In some cases, a location may be automatically selected or automatically suggested to the user. For example, the user's current location (e.g., as reported by a GPS or other positioning system integrated with or otherwise associated with the device 200) may be compared against a list of known locations (e.g., retail stores, restaurants, etc.). If the user's location is within a first threshold distance of a known location (and/or if there are no other known locations within a second threshold distance of the user's location), the known location may be automatically selected for association with the workflow data. In cases where the location is automatically suggested to the user, the user may have an opportunity to accept the suggestion, or reject the suggestion and instead select an alternative location.

Each location may be associated with data such as a name 206 (e.g., 206-1, . . . , 206-n), a street address 208 (e.g., 208-1, . . . , 208-n), and a distance from the user's current location 210 (e.g., 210-1, . . . , 210-n). Other information may also be displayed in conjunction with each location 204.

Once a location is selected, the workflow may transition to an image capture operation. FIG. 2B depicts an example interface for capturing an image with a camera that is integrated with the device 200 (or with any other suitable electronic device, such as a tablet computer or laptop computer). The device 200 displays an image preview 216 illustrating what will be captured by the integrated camera. The device 200 may also display an image capture button 212 that, when actuated by a user touching the portion of a touchscreen corresponding to the button 212, causes the integrated camera to capture the image.

The image being captured may be an image of an array of physical items 214 (e.g., 214-1, . . . , 214-n). For example, in the case where the instant workflow is used to provide product data for beverage displays (e.g., refrigerated display cases, aisle endcaps), the array of physical items may include an array of bottles, cans, and/or other beverage containers (as shown in FIG. 2B). The image may also include other physical items such as price tags, promotional placards, advertisements, and the like. FIG. 2B includes an example promotional placard 215. Other physical items may also be analyzed instead of or in addition to beverage containers, such as food items or other goods (including, for example, any items that are displayed for purchase in stores). In such cases, the image that is captured may include an array of those physical items.

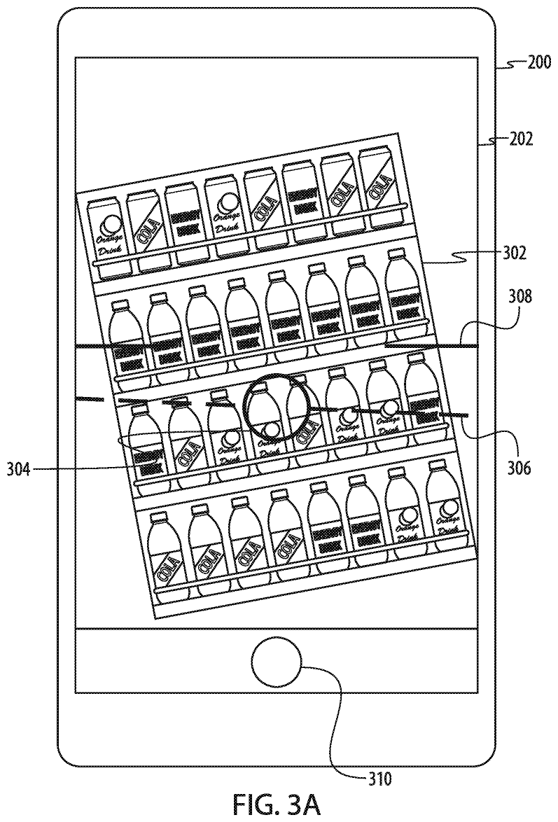

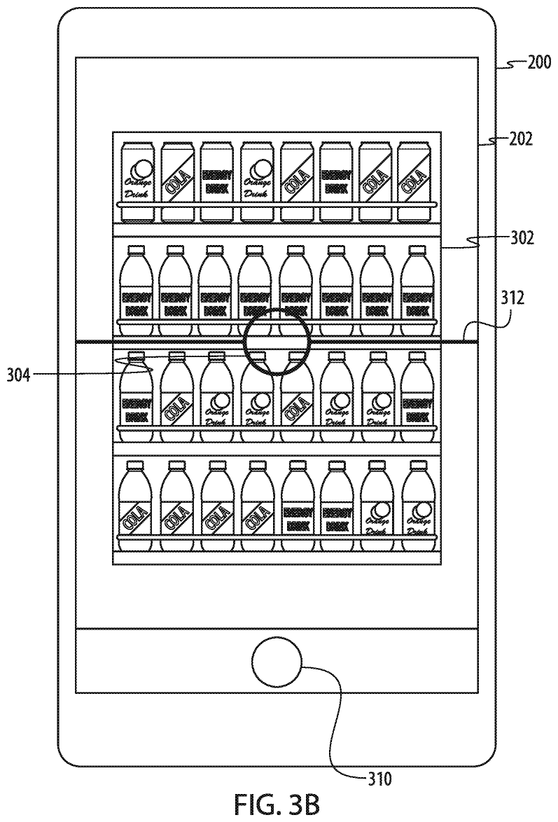

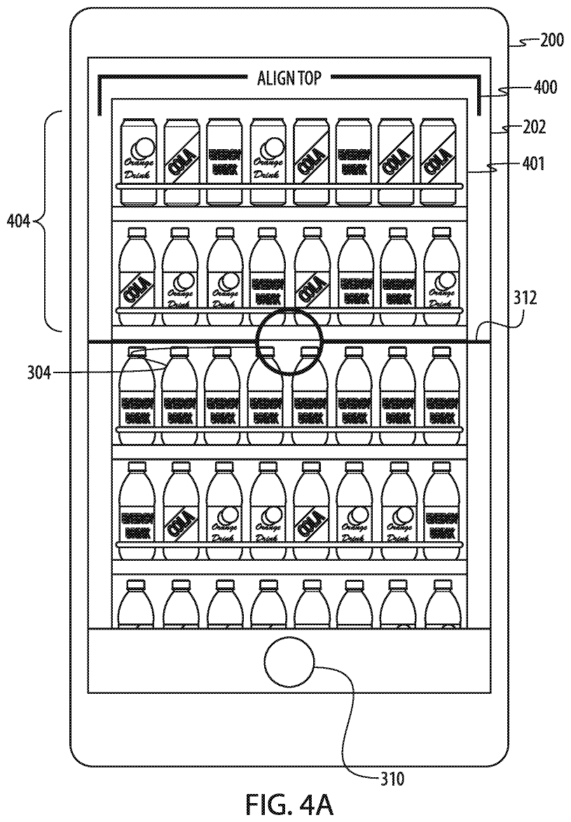

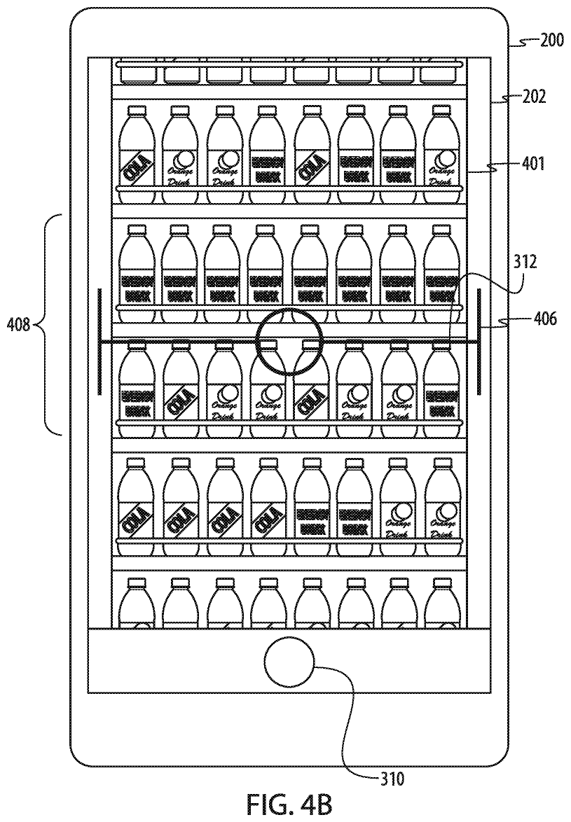

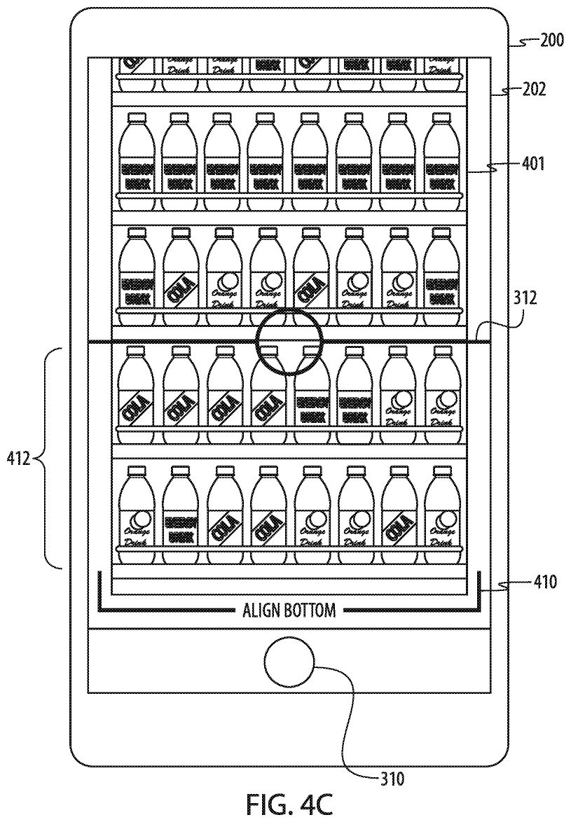

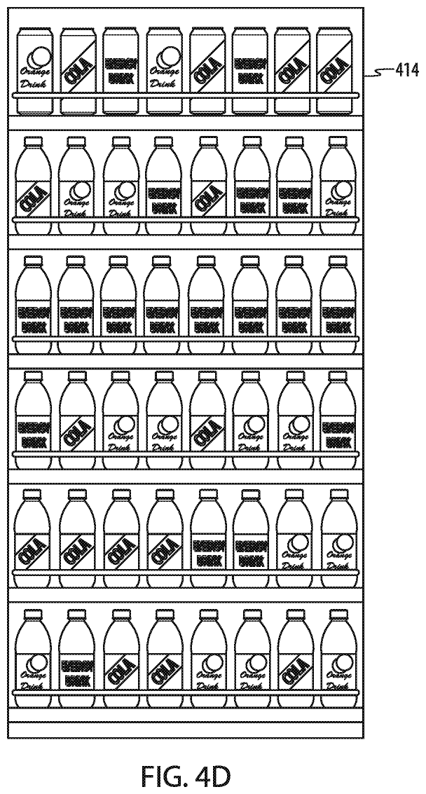

In some cases, visual guides may be displayed on the display 202 to help the user align the physical objects in the frame of the image. Additionally, where the size and/or shape of a display makes it difficult to capture the entire display in a single image, the workflow may prompt a user to take multiple images of the display, which may then be stitched together to form a composite image of the display. Example visual guides and an example photo stitching workflow are described herein with respect to FIGS. 3A-4D.

After the image is captured, a preview of the image may be displayed on the device 200 so that the user can review and confirm that the image is sufficient. FIG. 2C illustrates an example interface depicting a preview 218 of the image captured by the user. The interface may display a retake button 220 that allows the user to retake the image if the image is blurry, incomplete, improperly rotated, poorly stitched, or the like (or for any other reason). The interface may also display a submit button 222. Once the user determines that the image is of suitable quality, selecting the submit button 222 may cause the device 200 to send the image to a remote server for analysis.

The image may also be associated with a particular device or appliance located within the store so that it may be differentiated with respect to other devices or appliances within the store. For example, the user interface may prompt the user to enter a device location or number that is associated with the designated location. In some cases, a list of options for known devices or appliances is uploaded to the device in response to the location of the visit being designated. The user may then be allowed to select from the list of options to indicate which device or appliance is being photographed.

The remote server 102 (or other computer or computing system) may use the image analysis engine 110 to perform automated item recognition operations on the captured image. For example, the remote server may implement one or more of the workflows described above with respect to FIGS. 1C-1E to analyze the captured image. In some cases, as noted above, the device 200 may perform automatic image analysis operations using machine learning models that are based on or otherwise configured to produce similar results as the image segmentation module 114 and the segment identification module 116, described above.

The use of machine learning models for the image analysis engine (and other machine-learning based engines described herein) may improve the efficiency and speed of the image analysis and compliance metric determinations described herein. For example, machine learning algorithms essentially condense a large amount of training data (e.g., labeled images) into a mathematical model (referred to herein as a machine learning model or trained product model). It may be faster and more efficient to apply the machine learning model to an image rather than comparing the image against all the images in the training data. This efficiency also facilitates greater use of offline or remote processing, as smaller, less powerful devices (e.g., mobile phones), which would not be able to efficiently perform an image comparison against a large corpus of images, may be able to apply the machine learning model. Accordingly, not only do the machine-learning based engines make the image analysis and compliance metric processes faster, but they allow the use of less powerful computing systems and thus enable mobile devices to perform the processes in real-time in the field.

In some cases, the output of the image analysis engine may be a data set (e.g., an image annotation data set) that identifies the location, size, and shape of one or more segments in the input image, where each segment contains or otherwise corresponds to an item of interest in the image (e.g., a beverage container). The data set may further include a product identifier and/or product information (e.g., a UPC code, a product name, a product brand, a product identifier, a stockkeeping unit (SKU), etc.) associated with one or more of the segments. This data set (e.g., the image annotation data set) in conjunction with the input image may be referred to as an annotated image.

The remote server may attempt to associate product information with each identified physical item and may produce an annotated image that includes respective product information for respective identified physical items. (The product information may be any suitable product information, such as a brand name, a product name, a product type, a container size, a product class or category, or any other suitable information (or combinations thereof)). The annotated image may take the form of an image file with an accompanying data file. The accompanying data file may include information such as the location or region within the image file where each physical item is shown, as well as the product information for each physical item. In some cases, the image analysis engine may be unable to determine (to a sufficient degree of certainty) the product of an identified physical item in the image. For example, a label may be obscured, damaged, or otherwise not visible in the image. In such cases, the annotated image may flag the item that was not identified for further processing and review. As described with respect to FIG. 2J, the user of the device 200 may be prompted to manually associate product information with the identified item. As another example, an operator or user remote from the device 200 (e.g., an operator at the remote server) may be prompted to manually associate product information with the identified item.

Once the remote server associates product information with the physical items in the image, and either before or after a user manually associates product information with items that did not sufficiently match a known item, the remote server 102 (and/or the device 200) may analyze the image file and/or the accompanying data file to determine aggregate information about the contents of the product display. For example, the remote server may determine how many instances of a particular product are present in the image. As a specific example, the remote server may determine that a given image has 15 instances of an energy drink from “brand 1,” seven instances of a cola from “brand 1,” and 3 instances of a coffee drink from “brand 1.” As used herein, an instance of an item or product in an image may refer to the front-facing item in a tray of items. For example, a refrigerated beverage display case may have multiple trays, each containing one or more containers that extend into the display case. When the front-most container is removed from a tray, another container (typically of the same product) slides forward to the front of the tray or is otherwise visible from the front of the display. Accordingly, a count of instances of a product in an image may not correspond to an inventory of products, but rather how many trays of a given product are present.

The remote server 102 (and/or the device 200) may determine other aggregate information instead of or in addition to a number of instances of a particular product. For example, the remote server 102 or device 200 may determine the number of products from a particular brand, or the number of products in a particular category (e.g., energy drinks, coffee/tea, carbonated soft drinks, enhanced water, plain water, etc.). Indeed, the aggregate information may be or may include any information that is included in or derivable from the data associated with an annotated image, including from any product information that is associated with the items in the image.

Turning to FIG. 2D, after the user submits the captured image to the remote server 102 for analysis, the device 200 may display a dashboard view 224. The dashboard view 224 may show a list of historical visit identifiers 226 (e.g., 226-1, . . . , 226-n), each including associated information such as a location name, address, and a time/date of visit.

Each visit identifier 226 may also be associated with a status indicator 232 (e.g., 232-1, . . . , 232-n). The status indicators 232 may indicate the status of the analysis being performed by the remote server. For example, the status indicator 232-1 has a different appearance than the status indicators 232-2 and 232-3, indicating that the analysis for the image or images associated with site visit 226-1 has not yet been completed. As described above, the analysis by the remote server may take only a short period of time, such as less than about three minutes, less than about 90 seconds, or the like. Once the analysis is complete and available to be viewed by the device 200, the status indicator 232-1 may change appearance to indicate to the user that he or she may select the visit identifier 226-1 to view the data.

Each visit identifier 226 may also include a scene count 234 (e.g., 234-1, . . . , 234-n). The scene count may indicate how many images were captured at the indicated location on the indicated visit. As used herein a “scene” may correspond to one display unit at a store, such as one cold vault, one cold box, one aisle endcap, or the like.

In some cases, the device 200 may automatically navigate to the dashboard view 224 after the captured image is submitted for processing. In other cases, the dashboard view 224 may be skipped and the device 200 may navigate instead to the interface shown in FIG. 2F. The dashboard view 224 may also be reachable from other interfaces as well, allowing a user to navigate to the dashboard view 224 at any time (e.g., to view historical visit data).

Once the remote server 102 has completed an image analysis operation on the image sent by the device 200, the remote server 102 may return data to the device 200. The data may include an analyzed image and associated metrics, data, and the like. The data returned to the device 200 may be the result of the image analysis operations described with respect to any of FIGS. 1C-1E.

Once the data has been returned to the device 200, a user may select a visit identifier 226 (e.g., 226-1) to view data received from the remote server. FIGS. 2E-2H illustrate an example data report interface 237 corresponding to the visit identifier 226-1 in FIG. 2D. The data report interface 237 includes a visit identifier 236 and may have multiple sections, such as an overview section 239 and a scene section 235. FIGS. 2E-2G illustrate the overview section 239, and FIG. 2H illustrates the scene section 235.

With reference to FIG. 2E, the data report interface 237 may present a “facing total” 238 that indicates the number of product facings (e.g., instances of physical items in the captured image or images that were sent to the remote server) in the scenes associated with that visit. As noted above, the facing total 238 may include the aggregate number of facings for all images or scenes associated with that visit. The data report interface 237 may also include a supplier graph 242 depicting the relative share of facings per supplier. Thus, referring to the graph key 244, “supplier 1” may have 52.9% of the total facings, “supplier 2” may have 44.1% of the total facings, and “supplier 3” may have 2.9% of the total facings.

The data report interface 237 may also include a brand family analysis section 245. This section may list brand families 250 (e.g., 250-1, . . . , 250-n) that are represented or found in the captured images. As described herein, a supplier may correspond to a parent company or entity (e.g., PEPSICO™), while the brand families may represent a particular product brand that is supplied or manufactured by the parent company (e.g., MOUNTAIN DEW™). Each brand family listing may include a raw facing number 246 (e.g., 246-1, . . . , 246-n) indicating the total number of facings of that particular brand family. With reference to FIG. 2F (which shows the data report interface 237 of FIG. 2E after a user has scrolled to a different part of the interface), the data report interface 237 may also include a category analysis section 247. The category analysis section 247 may list various categories of products and their raw facing number 249 (e.g., 249-1, . . . , 249-n) indicating the total number of facings of that particular product category.

The data report interface 237 may also include compliance information representing an extent to which the actual facing totals for the supplier, brand families, and/or product categories match a target value. One component of the compliance information is a share total 240 (FIG. 2E) which represents a percentage of a target for product facings. For example, if a target for a particular store is 23 product facings from supplier 1, and the total facings associated with that supplier (as reported by the image analysis engine described above) are 18 facings, the share total may be 78%.

In addition to or instead of the overall share total 240, the compliance information in the data report interface 237 may include action items 248 (e.g., 248-1, . . . , 248-n) and 252 (e.g., 252-1, . . . , 252-n). The action items 248, 252 may indicate actions that the user may take to bring the store into compliance with the target facing values. For example, “brand family 1” 250-1 may be associated with a target of 13 facings, but the captured image may indicate that 15 facings are present. Accordingly, the action item 248-1 is “−2,” indicating that removal of 2 facings (e.g., two trays of “brand family 1” from the cold vault) will bring “brand family 1” into compliance with its target value. Similarly, “brand family 3” 250-3 may be associated with a target of 5 facings, but the captured image may indicate that only 4 facings are present. Accordingly, the action item 248-3 is “+1,” indicating that adding 1 facings of “brand family 3” to the cold vault will bring “brand family 3” into compliance with its target value. If all action items in the brand family analysis section 245 are complied with (or of all product facings match their targets), the “share total” value may be reported as 100% or some other value indicating that the target for that particular store has been reached (e.g., “target reached,” “full compliance,” or the like).

The action items 252 in the category analysis section 247 (FIG. 2F) may represent another way to reach compliance with a target value. In some cases, performing either one of the sets of action items 248, 252 will result in full compliance, while in other cases, both sets of action items must be performed in order to reach full compliance.

FIGS. 2E and 2F illustrates a data report interface in which the data is reported for all of the products in an image. In some cases, however, it may be desirable to filter the results in various ways. For example, it may be desirable for competitive purposes to know how various different suppliers are stocking their products. FIG. 2G illustrates the example data report interface 237 after a user has selected a filter category. More particularly, in this example, the “supplier 1” text has been selected, causing the interface 237 to limit the displayed information to that supplier's products. For example, the graph 281 may be updated to reflect the relative amounts of supplier 1's products in the captured scene. Names or other product identifiers 282 (282-1, . . . , 282-n) may also be displayed along with their respective percentage of the supplier's total products. A user may select the other suppliers (or other filtering criteria) to cause the data report interface 237 to update the displayed data according to the selected filter.

The data report interface 237 shown in FIGS. 2E-2G is merely one example of an interface for reporting data that is gleaned from an image by the image analysis engine. It will be understood that other ways of presenting the data may be used instead of or in addition to those shown. Moreover, the layout, graphics, and organization of the data report interface 237 may be different from that shown in FIGS. 2E-2G. Finally, more, less, or different data may be presented in other implementations of the data report interface 237 without departing from the spirit and scope of the instant application.

FIG. 2H shows an example scene section 235 of the data report interface 237. As described above, a scene may correspond to an image of a display, such as a cold vault, cold box, aisle end cap, vending machine, or the like. The scene section 235 may include a list of scenes 254 (e.g., 254-1, . . . , 254-n) associated with a particular visit at a particular location. Each scene 254 may be individually selected to cause the annotated image of the scene (which was received at the device 200 from the remote server, as described above) to be displayed to the user. In some cases, the scenes 254 in the list may each include a status identifier 256 (e.g., 256-1, . . . , 256-n). The status identifier may indicate whether or not each item that was identified in the captured image was successfully associated with product information or a product identifier. For example, the status identifier 256-1 shows that the status is incomplete, thus prompting the user to select that scene to provide additional information about the products in the image. The status identifier 256-2 shows that the status of that scene is complete, indicating that all of the identified items have been labeled with product information.

When a scene is selected from the scene section 235 (e.g., the scene 254-1), a scene audit interface 258 may be displayed, as shown in FIG. 2I. The scene audit interface 258 may include an annotated image 260, corresponding to the captured image that was then analyzed and annotated by the image analysis engine. The annotated image 260 may include visual indicators (e.g., the visual indicator 261) indicating the locations in the image where items, such as beverage containers, were detected. When the visual indicators are selected (e.g., by touching on the screen of the device 200), the device 200 may display product information related to the product associated with the selected visual indicator. Product information 264 (e.g., 264-1, . . . , 264-n) may also be displayed for each item in the annotated image 260. Additional product information (e.g., container size, etc.) may be displayed in response to a selection of an affordance 265. In some cases, selecting one of the visual indicators will cause associated product information 264 to be prominently displayed (e.g., highlighted, shown in a separate page or interface or popup window, or the like).

In cases where the image analysis engine was not able to associate product information with detected items in the image, those items may be distinctly indicated in the scene audit interface 258. For example, items without a product identifier or product information (e.g., segments whose contents were not able to be identified with a sufficient confidence metric to satisfy a confidence condition) may be associated with distinct visual indicators 262 (e.g., 262-1, . . . , 262-n). These indicators may prompt the user to select those items and provide the missing product data (and/or confirm or reject suggested product information).

FIG. 2J illustrates an example item audit interface 266 that allows a user to associate product information with items. The item audit interface 266 may appear in response to a user selecting one of the items associated with the distinct visual indicators 262 in FIG. 2I (e.g., indicator 262-1). The item audit interface 266 includes a preview image 268 of the item. More particularly, the preview image 268 may be a portion of the larger captured image that contains an item that has not been identified. The preview image 268 may correspond to a segment produced by an automatic segmentation operation (e.g., by the image segmentation module 114, or by an on-device machine learning model configured to determine segments within the image).

The item audit interface 266 also includes product information selection buttons 270 that allow a user to select the product in the image. In some cases, after a user selects one of the product information selection buttons 270, another set of product information selection buttons appears. For example, the first set of product information selection buttons may include supplier names, and once a supplier is selected, a set of brand families associated with that supplier may be displayed. After a brand family is selected, a set of products associated with that brand family may be displayed. This process may continue until complete product information is provided (e.g., until an exact UPC or other product identifier for the product in the image 268 is determined). In some cases a user may be able to manually enter product information, take a new image of the product (e.g., after removing the product from the display case), scan a barcode of the product, manually enter a universal product code number, or the like. Because the user is manually verifying the product in the image, the product identifier that is associated with the image in this operation may be referred to as a verified product identifier.

After product information (e.g., a verified product identifier or information from which a verified product identifier can be determined) is received via the item audit interface 266, the received product information may be associated with the annotated image. The annotated image with the updated product information (received via the item audit interface) may be stored on the device 200 and/or returned to the remote server. The updated product information and/or identifier may be used to further train the image analysis engine to improve future product identification results.

FIG. 2K illustrates another example item audit interface 283 that allows a user to associate product information with items. The item audit interface 283 may appear in response to a user selecting one of the items associated with the distinct visual indicators 262 in FIG. 2I (e.g., indicator 262-1). The item audit interface 283 includes the image 268 of the item (e.g., a segment produced by an automatic segmentation operation).

Instead of requiring a user to manually select product information to be associated with the image 268, the item audit interface 283 may prompt a user to capture a barcode of the product shown in the image 268. This may allow the user to associate an actual product identifier more quickly and accurately than the manual input described with respect to FIG. 2J.

The item audit interface 283 may include an image preview area 287 that shows a preview of the device's camera. More particularly, a camera function of the device 200 may be initiated, and the image preview area 287 displays a preview illustrating what will be captured by the camera.

The item audit interface 283 may also include visual guides 284 that indicate where a barcode 285 (on the product) should be positioned while it is captured. The item audit interface 283 may also include a barcode capture button 286 that, when pressed, causes the device 200 to capture an image of the barcode 285. Once the image is captured, it may be analyzed by the device 200, and/or sent to a remote computer (e.g., the server 102) for analysis, to determine a UPC or other product identifier in the barcode. For example, the image of the bar code may be decoded by the device 200 to determine a product identifier (e.g., a UPC) encoded in or otherwise conveyed by the bar code, and the product identifier may be sent to the remote computer. As another example, the image of the bar code may be sent to the remote computer, and the remote computer may decode the bar code to determine the product identifier. The product identifier (e.g., the UPC) may then be associated with the image 268. Because the user is manually verifying the product in the image by scanning the actual barcode of the image, the product identifier that is associated with the image in this operation may be referred to as a verified product identifier.

After an image of the barcode 285 is captured, the device 200 may automatically advance to the next segment that was not able to be identified with a sufficient confidence metric, showing an image of the new segment and requesting that the barcode be scanned. The device 200 may proceed in this manner until barcodes have been captured for all of the segments with insufficient confidence metrics.

Because the image analysis engine operates in real-time to provide annotated images within seconds or minutes, a user may be able to perform item audits during the same visit that the original scene was captured. In this way, more complete and accurate product information may be collected. In particular, if product labels are obscured or there is a new product that would not otherwise be able to be identified, the rapid, real-time image analysis means that the user may still be at a particular location when it is determined that a product cannot be identified. This allows the user to manually identify the product by picking up or manipulating the product—actions which would not be feasible or possible if the image analysis occurred hours or days after the visit.

FIG. 2L illustrates an example product information interface 272. This interface may be displayed when a user selects a product (e.g., a visual indicator 261 associated with a product) to view product information. The product information interface 272 includes the annotated image 260. The visual indicator associated with a product 274 is displayed visually distinctly, allowing the user to see exactly which product has been selected. Product information 276 associated with the selected product 274 is shown. Product information 276 may include any suitable product information, including but not limited to a supplier, brand family, a product identifier (e.g., a UPC), container size, product category, and a position in the scene (e.g., row and column values).

FIG. 2M illustrates the product information interface 272, showing information that has been extracted from a promotional placard 215. The promotional placard 215 may have been analyzed to detect text on the placard, and to associate the text with certain types of information. When the promotional placard 215 is selected in the image 260 (e.g., by user clicking or pressing on that segment), information 288 from the promotional placard 215 is shown in the product information interface 272. For example, the information 288 in FIG. 2M includes a brand family, brand, size, and deal price. Of course, other types of information may be provided, and the type of information may depend at least in part on what information is presented on the placard 215. The interface 272 may also show an annotated image segment 299 of the placard 215, showing what portions of the placard 215 were found to have text from which the information 288 was extracted or derived. In some cases, the user can modify the information 288 in the event that text on the placard 215 was not identified, was incorrectly detected, or the like. The user may also be able to flag the annotated image segment 299 for further review or audit (e.g., by a remote operator).

The promotional placard 215 may have been analyzed using the image segmentation module 114, the segment identification module 116, one or more machine learning models resident on the device 200, or via other techniques. Further, while FIG. 2M illustrates how information from a promotional placard 215 may be presented, the systems described herein may analyze other types of textual content in order to extract and/or derive information of interest (e.g., prices, deals, new product releases, and the like).

In many cases, it may be desirable to determine information other than simply what product is present in a display. For example, beverage multipacks (e.g., 6-packs, 12-packs, 24-packs, etc.) may be positioned on a shelf in various orientations, and the particular orientation may be of interest for competitive analysis and to determine compliance with stock agreements, target display metrics, and the like. More particularly, a 12-pack that is oriented so that its front (e.g., the side with the largest area) is facing outward may be more effective from an advertising or marketing standpoint than one that is oriented so that its end (e.g., the side with the smallest area) is facing outward. In particular, a front-facing 12-pack may present a larger and more prominent logo than an end-facing 12-pack, and may occupy more space on the shelf, leaving less relative space for competitors.

Accordingly, the image analysis engine 110 may be configured to identify multipacks in images, identify the products in the multipacks, and determine how the multipacks are oriented on the display. More particularly, the image segmentation module 114 may determine segments of images that correspond to or contain multipacks, and the segment identification module 116 may be configured to determine what product is shown in the multipack segments, and the orientation of the multipack. The segment identification module 116 may use a machine learning model that is trained on a corpus of segments that depict multipacks in various orientations, and that are labeled with the particular side that is facing outward in the segments.

FIG. 2N illustrates an example image capture interface for capturing an image with a camera that is integrated with the device 200 (or with any other suitable electronic device, such as a tablet computer or laptop computer). The device 200 displays an image preview 289 illustrating what will be captured by the integrated camera (here, an image of a display or refrigerated case that includes beverage multipacks). The device 200 may also display an image capture button 290 that, when actuated by a user touching the portion of a touchscreen corresponding to the button 290, causes the integrated camera to capture the image. As described above, the captured image may be sent to the image analysis engine 110 to be analyzed according to a workflow (e.g., one of the workflows described with respect to FIGS. 2C-2E). Alternatively or additionally, the device 200 itself may analyze the image using machine learning models.

FIG. 2O illustrates an example product information interface showing the results of an image analysis of the image captured in FIG. 2N. As shown, the annotated image 291 may depict a bounding box around each individual segment. When a segment is selected by a user, information about that segment may be displayed on the device 200. For example, FIG. 2O shows the segment 292 having been selected. The device 200 thus displays information 293 that relates to the multipack shown in the segment 292 (which may have been determined, for example, by the image analysis engine 110). The information 293 may include a brand family of the multipack (e.g., “Brand 1”), a brand of the multipack (e.g., “Fizzi Water”), and a facing orientation of the multipack (e.g., “Front”). Of course, other types of information may be provided instead of or in addition to that shown in FIG. 2O.

FIG. 2P illustrates another example product information interface showing the results of an image analysis of the image captured in FIG. 2N, where the segment 295 is selected so that information 296 relating to the segment 295 is displayed. Whereas the information 293 indicated that the multipack was oriented so that the front was facing outward, the information 296 correctly reflects that the multipack in the segment 295 is oriented so that its end is facing outward.

FIGS. 3A-4C illustrate example camera interfaces that may be used on a mobile device (e.g., the device 200) to assist a user in capturing suitable images for submission to the image analysis engine. FIGS. 3A-3B illustrate an example interface where an entire scene (e.g., cold box, cold vault, aisle endcap) fits into a single frame of the camera while occupying most of the frame. FIGS. 4A-4C illustrate an example interface that may be used to capture multiple images to be stitched together, such as where the entire scene does not fit into the frame.

With reference to FIG. 3A, the device 200 may show a preview of the image to be captured on the display 202. FIG. 3A shows an image of a scene 302 that can fit entirely within the frame of the camera and occupies substantially all of the frame. This indicates that the image will have sufficient resolution to facilitate accurate item recognition. The preview interface includes an alignment target 308, represented as a horizontal line along the middle of the frame, as well as a current rotation indicator 304 and a current tilt indicator 306. The image is considered aligned when the current rotation indicator 304 and the current tilt indicator 306 are aligned with the alignment target 308. FIG. 3B illustrates the preview interface when the image is successfully aligned. A graphic 312 may indicate that alignment is successful and that the image may be captured (e.g., by pressing or touching an image capture button 310).

With reference to FIGS. 4A-4D, in cases where the entire scene does not fit into the frame while maintaining sufficient resolution of the scene, such as where the scene to be captured is tall and narrow and thus would be too small if captured in a single photograph, the device 200 may prompt a user to take several photographs of the scene. These partial scenes may then be stitched together to form a composite image of the entire scene (e.g., an entire cold vault or refrigerated display case).

As shown in FIG. 4A, the preview interface may include a top alignment indicator 400 that guides the user to align the top portion of the scene 401 (e.g., the top rows 404 of a cold vault or refrigerated display case) in a particular region of the camera frame. The graphic 312 indicates that the scene is aligned and that the image may be captured.

FIG. 4B shows the preview interface prompting the user to capture a middle portion of the scene 401. The preview interface includes a middle alignment indicator 406 that guides the user to align the middle portion of the scene 401 (e.g., the middle rows 408) in a particular region of the camera frame. The graphic 312 indicates that the scene is aligned and that the image may be captured.

FIG. 4C shows the preview interface prompting the user to capture a bottom portion of the scene 401. The preview interface includes a bottom alignment indicator 410 that guides the user to align the bottom portion of the scene 401 (e.g., the bottom rows 412) in a particular region of the camera frame. The graphic 312 indicates that the scene is aligned and that the image may be captured.

Once all of the images are captured, they may be stitched together to form a single composite image. FIG. 4D illustrates an example composite image 414 formed by stitching together the three partial images captured during the process described in FIGS. 4A-4C. The stitching may be performed by the device 200, or by a remote device (e.g., the remote server). By stitching on the device, processing time may be reduced relative to a remote stitching process where the images must be sent to a remote server and the composite image received back. If the composite image appears acceptable to the user (e.g., the image appears to be complete and lack discontinuities), the user may submit the image for automatic item recognition as described above with respect to FIG. 2C.

FIGS. 4A-4D describe a stitching process and user interface for stitching together an image using several horizontal slices (e.g., to create a composite image having its longest axis a vertical axis). This process may be equally applicable to a process for stitching together several vertical slices (e.g., to create a composite image having its longest axis a horizontal axis, such as when forming a composite image of a grocery store aisle). Further, FIGS. 4A-4D describe capturing and stitching three partial images, though more or fewer partial images may be captured and stitched together to form the composite image.

The operations described with respect to FIGS. 2A-4D may be performed by any single computing system or a combination of computing systems. For example, in some cases all operations other than image capture is performed by a remote server (e.g., the remote server 102, FIG. 1A). In other cases, all of the operations are performed by a mobile device (e.g., the mobile device 101, FIG. 1A). In yet other cases, some operations are performed by a mobile device and others by a remote server. Performing operations on the mobile device may allow faster overall performance of the system, as the time to send images to and receive data from the remote server may be eliminated. Moreover, performing the operations on the mobile device can allow all or part of the workflow to be completed even if the mobile device lacks real-time communication connectivity with the remote server. This may allow for the workflow to be completed even in remote locations or where cellular or other communications networks are not available or are not functioning.

In one example, as described above, images may be captured by a mobile device and sent to a remote server for further processing and analysis. In such case, image processing operations (e.g., segmenting the image and associating product information and/or product identifiers with the products in the image) may be performed by the remote server. These operations may be completed in a short time, such as about one minute, about 30 seconds, or any other suitable time frame. Subsequent operations, such as determining compliance metrics or scores, determining action items, and the like, may then be performed by the remote server. These operations may also be completed in a short time, such as about three minutes, about two minutes, about one minute, or any other suitable time frame. Where multiple images are captured at a given location (e.g., where images of multiple cold vaults are captured), image processing and analysis and the determination of compliance metrics and the like may be performed in parallel for each image. Thus, once a first image is received by the remote server, the remote server may start the image analysis and compliance metric operations for that image. When a subsequent image is received, the image analysis and compliance metric operations for the subsequent image may be started even if the operations for the first image are not yet complete. A similar parallel processing schedule may be used when processing is performed entirely or partially on the mobile device.

In cases where image analysis and compliance metric analysis are performed on the mobile device, the mobile device may dynamically download programs, data, models, or other information based on the particular location where data is being collected to allow the mobile device to perform image and compliance metric analysis. For example, a machine learning model that has been trained for one supplier's products may be different than that for another supplier's products. Whereas a remote server may easily store multiple different models for multiple different suppliers, conventional mobile devices may not have sufficient storage capacity to store all of the models. Accordingly, the mobile device may download the model or models that are associated with a particular location when the user's location is determined (e.g., as described with respect to FIG. 2A). Downloading the model to the mobile device may include downloading algorithms, program code, images, or other data that are used to perform the image processing and analysis and compliance metric determinations described herein. In some cases, the downloaded models are purged from the mobile device at some point, such as immediately before downloading a subsequent model at a subsequent location, or at a particular time interval (e.g., each week, each day, each hour).

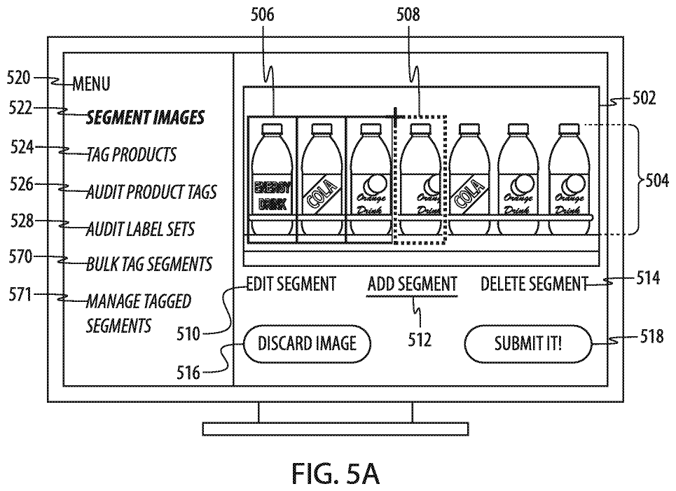

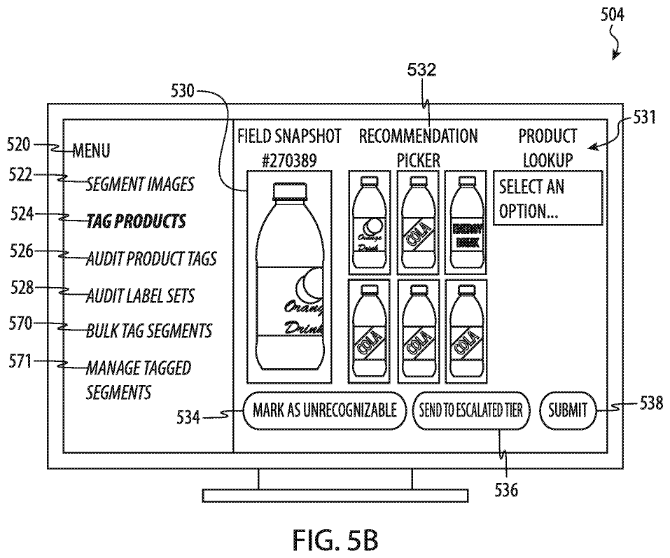

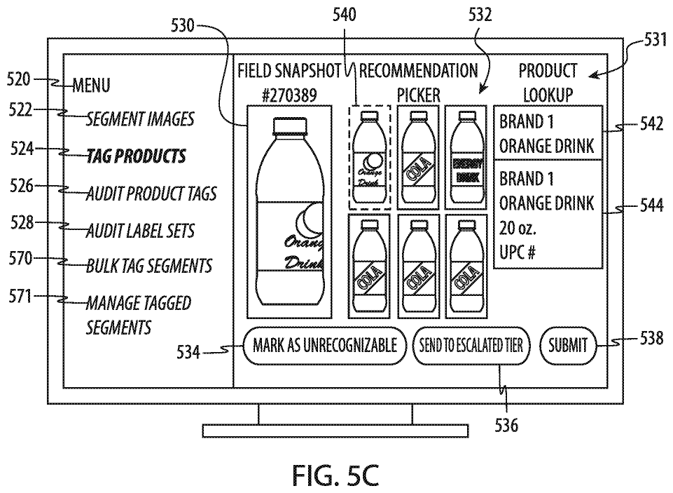

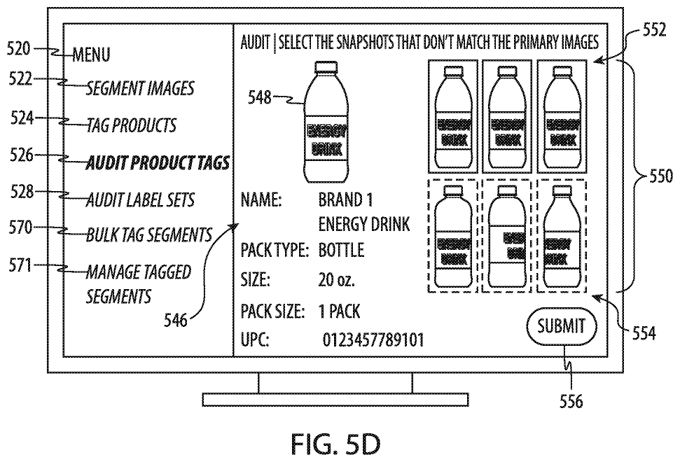

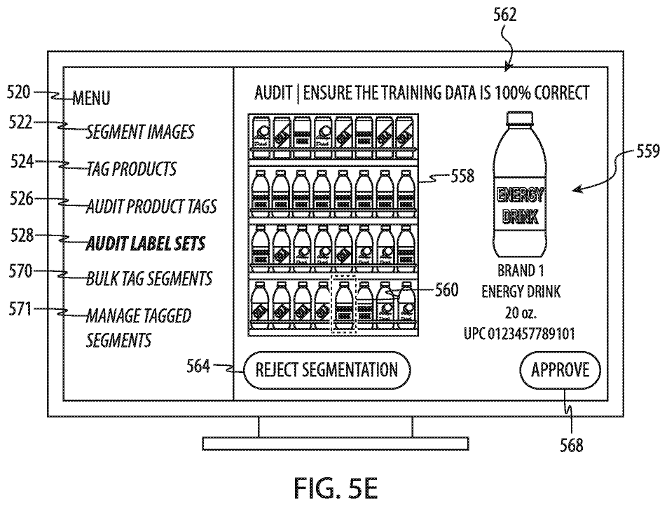

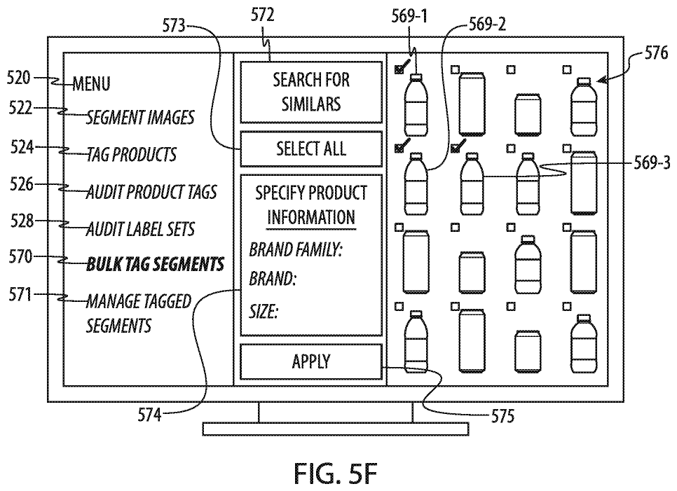

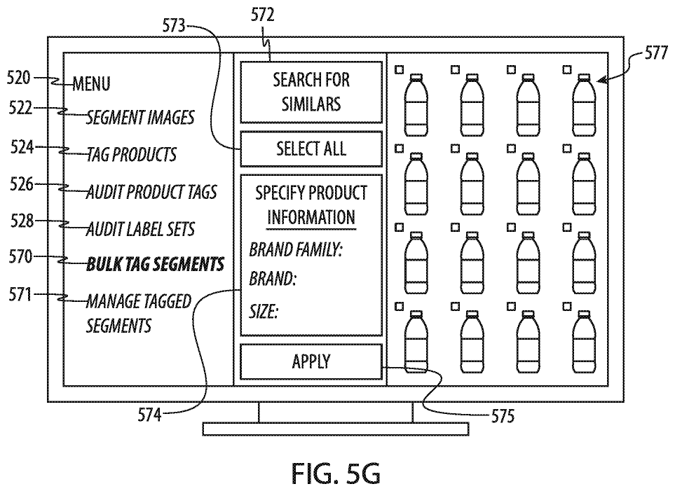

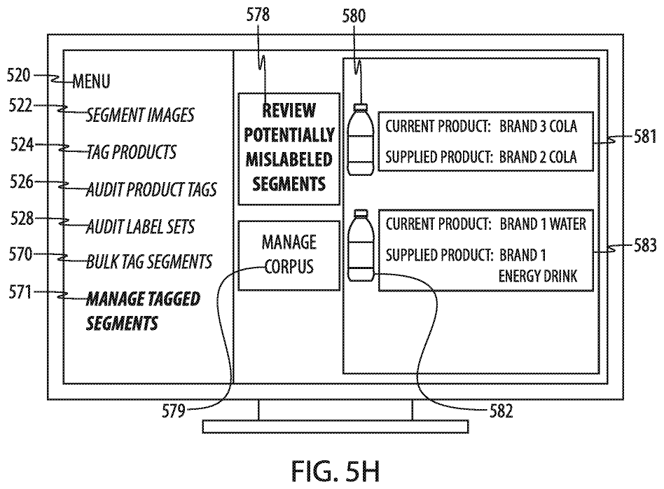

As noted above, images may be analyzed by an image analysis engine (e.g., the image analysis engine 110), which may reside on a remote server or other computing system (e.g., the server 102, FIG. 1A), or even on the mobile device that captured the image. The image analysis engine may use machine learning techniques to identify items in an image. For example, the image analysis engine may identify segments of an image that include a product or item of interest (e.g., a beverage container, a food item, or any other good or product), and then identify the contents of each segment to associate a product identifier with that segment. The machine learning model of the image analysis engine may be trained using training data of images that have been manually labeled with accurate product identifiers. For example, human operators may review real-world images of physical items (e.g., refrigerated beverage display cases) and manually identify the segments of the images that contain the items of interest, and associate product identifiers (e.g., UPCs, SKUs, or the like) with the various items. Many images may be analyzed in this manner to develop training data that is then used to train a machine learning model to segment images and associate product identifiers with the segments. FIGS. 5A-5E illustrate an example workflow for producing the training data for the machine learning model. The workflow described with respect to FIGS. 5A-5E may also be used or implemented by the manual image analysis module 118 to facilitate manual image segmentation and segment identification operations (such as when a segment identification operation does not satisfy a confidence condition, as described above).

FIG. 5A illustrates an example interface that defines a workflow for producing training data for the machine learning algorithm (e.g., the algorithm that is used to generate the ML model or trained product model). The interface may be part of an application that is executed by a computer system (e.g., a desktop computer, laptop computer, server computer, or the like). The interface may include a menu 520 that includes a list of operations or tasks in the workflow, including “segment images” 522, “tag products” 524, “audit product tags” 526, “audit label sets” 528, “bulk tag segments” 570, and “manage tagged segments” 571. These operations may define a workflow that is tailored to produce accurate and reliable training data, including various auditing operations that ensure accuracy and completeness of the training data. The items in the menu 520 may be selectable to allow an operator to navigate to the screen or interface associated with that operation.

The interface in FIG. 5A corresponds to the “segment images” operation. The interface includes an image 502 that includes an array (or part of an array) of physical objects. In the illustrated example, the image is a row 504 of beverage containers, but other items may be depicted. In this operation, a user is prompted to identify segments of the image that correspond to or include one of the items of interest to the image analysis engine. Segment 506 is defined by a box displayed around a beverage container. The segments (e.g., the segment 506) may be defined by a user drawing or otherwise indicating the segment. For example, a user may manipulate a cursor to form a box around an item in the image, as depicted by box 508.

The interface includes selectable commands such as “edit segment” 510, “add segment” 512, and “delete segment” 514. The edit segment command may allow a user to change the shape and/or size of a previously created segment (e.g., segment 506). The add segment command may cause a segment creation cursor or other graphical element(s) to appear to facilitate the creation of a new segment (e.g., as represented by box 508). The delete segment may allow a user to delete a previously created segment.

The interface may also include a “discard image” command 516 that allows a user to discard an image if it is undecipherable or for any other suitable reason. Once a user has created segments for each item in the image 502, he or she may select a “submit” command 518 to move on to the next operation in the training workflow.

After the segmented image is submitted, the interface may advance to a “tag products” operation. FIG. 5B shows an example interface that a user may use to associate product information with the items in the segments identified in the segmentation operation (FIG. 5A). In some cases a user is shown segments from an image that the user segmented in an earlier segmenting operation, while in other cases the user is shown segments from a different image (e.g., an image that another user segmented).

The interface in FIG. 5B includes the menu 520, a segment 530 from a segmented image, a recommendation picker 532, and several commands including “mark as unrecognizable” 534, “send to escalated tier” 536, and “submit” 538. The recommendation picker 532 may include images of suggested items that may correspond to the item in the segment 530. The suggested items may be selected using a preliminary image recognition system that compares the segment 530 to other known segments or product images. In other cases, the suggested items are selected based on other criteria, and may not be selected based on the segment 530. The images in the recommendation picker 532 may be stock or curated photographs to allow the user to clearly see what product is depicted in each image. Alternatively, the images may be segments from other images that have already been associated with product information.

The user may have the option of selecting an item from the recommendation picker 532 (e.g., by clicking on or otherwise selecting an image from the recommendation picker 532), or by manually entering product information into a product lookup element 531. The product lookup element 531 and the recommendation picker 532 may be programmatically linked, so a selection of an item from the recommendation picker 532 causes product information to be populated into the product lookup element 531. FIG. 5C illustrates the interface of FIG. 5B after a user has selected an item 540 in the recommendation picker 532. Accordingly, the product name 542 and product information 544 is shown in the product lookup element 531. As noted above, instead of selecting an image from the recommendation picker 532 a user may simply type a product name into the product lookup element 531 or select from a menu of product names in the product lookup element 531.

If the product in the segment 530 is unrecognizable (e.g., there is no visible label or recognizable container feature), the user may select the “mark as unrecognizable” command 534. If there is no known product name or information or if the user is not confident in his or her selection of product information for the product in the segment 530 (or for any other reason), the user may select the “send to escalated tier” command 536. This may cause the segment 530 to be sent to another user (e.g., a supervisor) or department to have the product identified and have the correct product information associated with the segment 530. Otherwise, once the user is done selecting the product, he or she may select the “submit” command 538 to move on to the next operation in the workflow.

FIG. 5D illustrates an “audit product tags” interface in which users are tasked with reviewing multiple segments that have been associated with given product information to ensure that the products in each of those segments were correctly identified. For example, the interface may include a stock or clear image 548 of a known product, and a group of segments 550 that were identified as being instances of the known product (e.g., during the product tagging operation, described above). The user may review the segments 550 and select those that do not match the image 548. As shown, the top row of segments 552 all appear to be the same product as the image 548, while the bottom row of segments 554 appear different. Once the non-matching segments are selected (indicated by the dashed boxes), the user may select the “submit” command 556 to advance to the next operation. Selecting the submit command 556 may also cause the segments 552 that were properly identified to be flagged as “confirmed” (or otherwise suitably marked as having been audited), and cause the segments 554 that were not properly identified to be flagged for exclusion from the training data or for further review.

FIG. 5E illustrates an “audit label sets” interface. This interface may represent a final audit for an image that is to be used as training data for machine learning algorithm(s). In this interface, a user may be presented with an image 558 that has been segmented and tagged with product information. The user may select each segment in the image to display a corresponding summary 559 of that segment. For example, in response to a user selecting segment 560, the product summary 559 may display a reference image of the product as well as product information (e.g., brand, product type, container size, a product identifier, etc.). If all of the segments in the image 558 are associated with correct product information, the user may select the “approve” command 568, which may approve and submit the tagged images for use to train the machine learning model (e.g., to generate the machine learning model). Alternatively, if there are problems with the image 558, such as incorrect product information associated with segments, inaccurate or overlapping segmentation, or the like, the user may select the “reject segmentation” command 564 to exclude the tagged images or flag them for further review.

As described above, the image analysis engine may use machine learning models to process images captured by users in the field. For example, a first machine learning model, used by the image segmentation module 114, may identify segments in a captured image. This machine learning model may be generated using training data produced during the “segment images” operation described with respect to FIG. 5A. A second machine learning model, used by the segment identification module 116, may then associate a respective product identifier with each respective segment that was identified in the captured image. This model may be generated using training data produced during the “tag products” operation described above with respect to FIGS. 5B-5C (as well as the auditing and quality control operations described with respect to FIGS. 5D-5I).

To improve the accuracy and/or effectiveness of the machine learning models described herein, they may be periodically re-trained using an updated corpus. The corpus may be updated on an ongoing basis by including new images that have been accurately segmented and/or labeled. However, if the corpus includes erroneously segmented or labeled images, the models may be less accurate. For example, if a corpus includes segments of the same product but with different labels (e.g., one cola can labeled “cola” and another identical can labeled “energy drink”), the model may be less accurate at identifying the products in the segments. Thus, interfaces for managing and maintaining the corpuses that are used to train machine learning models may be provided, as described with respect to FIGS. 5F-5I.

FIGS. 5F-5G illustrate a “bulk tag segments” interface where segments can be tagged in bulk for the purposes of updating a corpus with multiple accurately tagged segments. The interface includes an array of segments 576. The segments 576 may be untagged or they may have been previously tagged either automatically or manually. As shown, the segments 576 are not all showing the same product. Accordingly, a user may select a subset of the segments that include the same product and use those segments as key segments for an image-based similarity search (initiated by button 572). As shown in FIG. 5F, for example, segments 569-1, 569-2, and 569-3, which are all images of the same product, have been selected. The user may then select to “search for similars,” and the system will perform a search for other segments that have a similar appearance to the segments 569-1, 569-2, and 569-3. The user may select one or multiple segments to use as the key segments. (While the segments 569-1, 569-2, and 569-3 may appear in the figures to be identical images, this is merely for ease of illustration, and it will be understood that the segments 569-1, 569-2, and 569-3, and those segments shown in the array of segments 576 more generally, are different images.)

FIG. 5G illustrates the “bulk tag segments” interface after the similarity search in FIG. 5F has been executed. As shown, the interface now shows an array of segments 577 where all of the segments show the same product. Upon reviewing the array of segments 577 and confirming that they all relate to the same product, the user may select a “select all” button 573, specify product information in the entry field 574, and apply the product information and/or product identifier to all of the selected segments. The user may also select individual segments, rather than selecting them all, which may be useful where the similarity search still returned erroneous segments. Also, the user may apply partial product information to the selected segments. For example, the segments may already be correctly tagged with the brand family and brand, but the product size may be missing. Thus, the user can update the segments to include the correct size information, without overwriting the other product information.

FIG. 5H illustrates an interface for reviewing potentially mislabeled segments. These segments may be automatically identified by the image analysis engine, or by operators who encounter segments that may be mislabeled and flag them for further review. The interface may display segments that have been identified as possibly mislabeled (e.g., segments 580, 582), as well as information 581, 583 indicating the current product information associated with those segments. The information 581, 583 may also include suggested alternative product information, which may be generated by analyzing the segment with the segment identification module 116. The user can select a segment and update the appropriate product information as necessary.

FIG. 5I illustrates an interface for reviewing a corpus of segments that are all labeled or otherwise associated with the same product identifier (e.g., the same UPC) to allow a user to remove segments that have been incorrectly associated with that UPC. For example, an array 586 of segments may be displayed. The user may review the array 586 and select segments (e.g., segments 587-1, 587-2) that do not correspond to the UPC. The user may then select an affordance 584 to remove the selected tags from the corpus. This process may disassociate the UPC in question from the selected segments. In this way, the corpus of segments for the UPC in question may be updated so that it does not include incorrect segments that may negatively affect or impact the effectiveness of the models that are trained using the corpus.

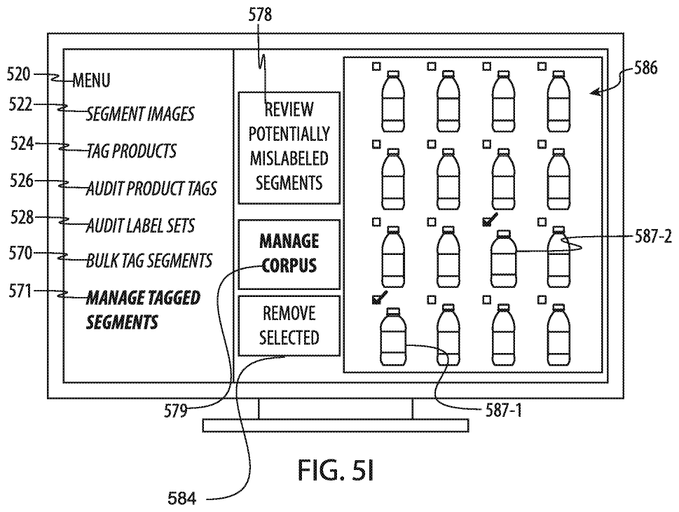

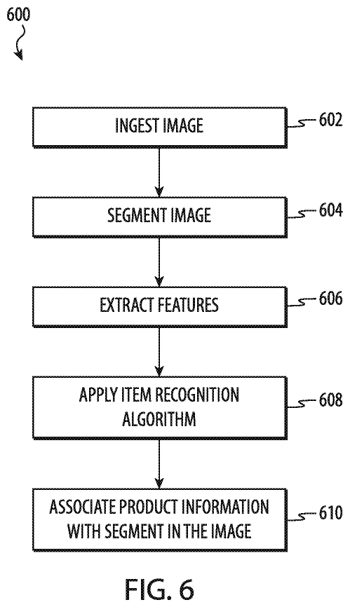

FIG. 6 is a flow chart of a process 600 for recognizing products in images and associating a product identifier (e.g., a UPC code) with each of the recognized products. This process may be performed by an image analysis engine executed by the remote server(s) 102 (FIG. 1A), or any other suitable computer or device(s). At operation 602, an image is ingested. The image may be the image that was captured using the integrated camera of a mobile device (e.g., the devices 101, 200 described herein). The image may be a digital image of any suitable format.

At operation 604, the image analysis engine segments the image. The operation of segmenting the image may be performed using a machine learning model trained with images having been manually segmented into appropriate segments, as described herein. For example, the segmenting may be performed by an image analysis engine. The segments may correspond to individual instances of physical items in the image and may be defined by a shape, size, and a location within the image.

At operation 606, features are extracted from the image and/or from the individual segments of the image. At operation 608, the features are analyzed with an image analysis engine. The image analysis engine may be or include a machine learning model trained with images (or segments of images) that have been manually tagged with product identifiers (e.g., UPC codes). The image analysis engine may output data indicating what products appear in each of the segments of the image. The image analysis engine may also provide a confidence value for each tagged segment indicating the degree of confidence in the identification of the product.

At operation 610, product information and/or product identifiers are associated with the segments in the image. For example, if a confidence value of a product identification from the image analysis engine satisfies a condition (e.g., above 80% confidence), the product information and/or the product identifier may be associated with the segment. Operation 610 may produce a data set that includes product information associated with at least a subset of the segments in the image. The data set may be used to produce compliance metrics, as described herein, and may be sent to mobile devices such as the mobile devices 101 (FIG. 1A). In some cases, the data set may be used in conjunction with the actual image to display an annotated image to a user (e.g., as described with respect to FIGS. 21, 2L-2M, and 2O-2P).

The foregoing description uses a display of beverages as an example subject to illustrate the systems, features, and techniques that use or are used with an image analysis engine as described herein. As noted above, however, beverages are merely one example product that may be analyzed using the instant techniques. For example, in some cases it may be desirable to determine compliance metrics (or other information) about dry goods that are available for purchase in grocery store aisles. The above techniques may apply equally to images of those types of displays as well.

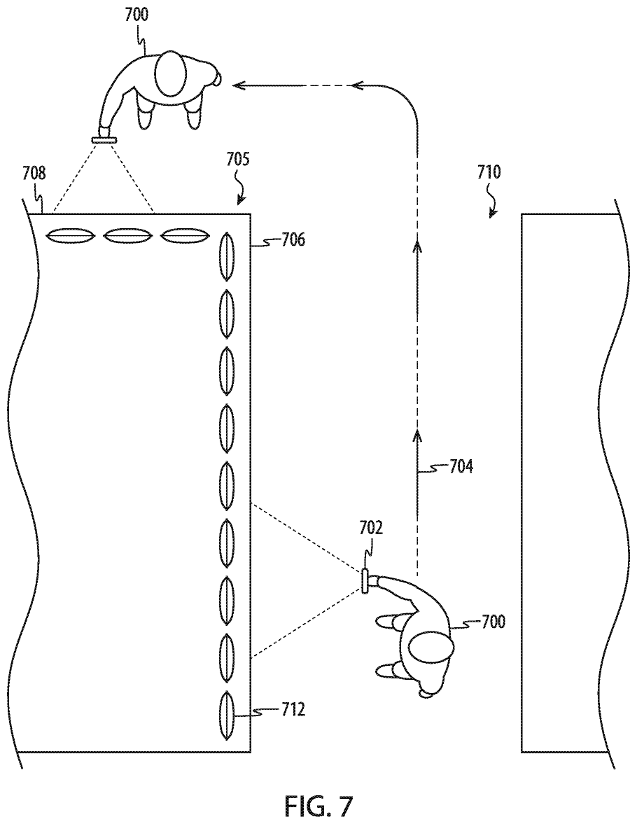

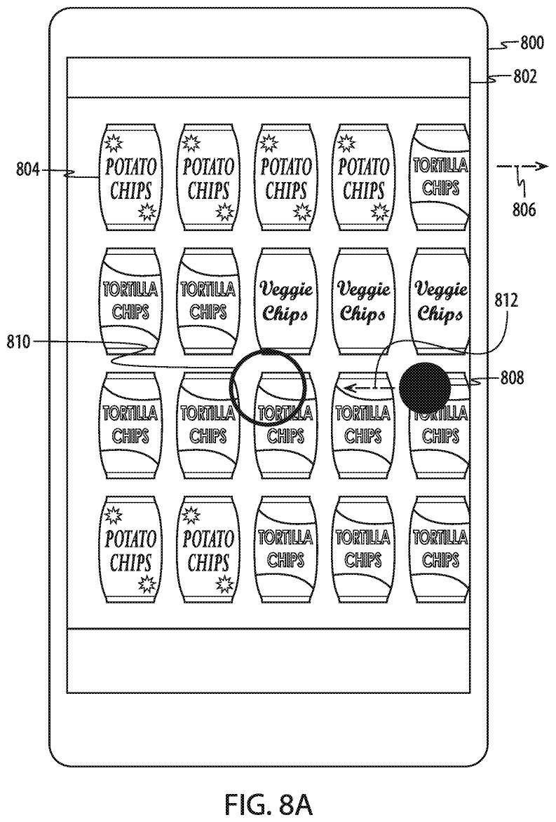

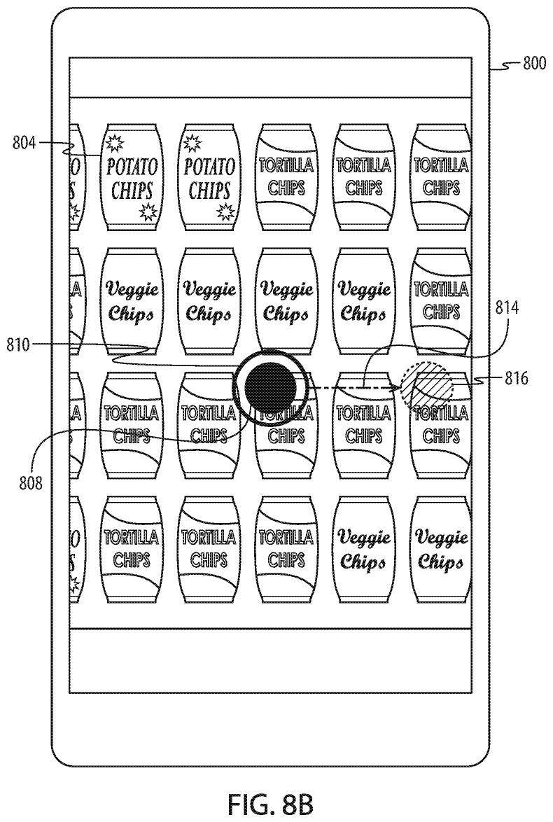

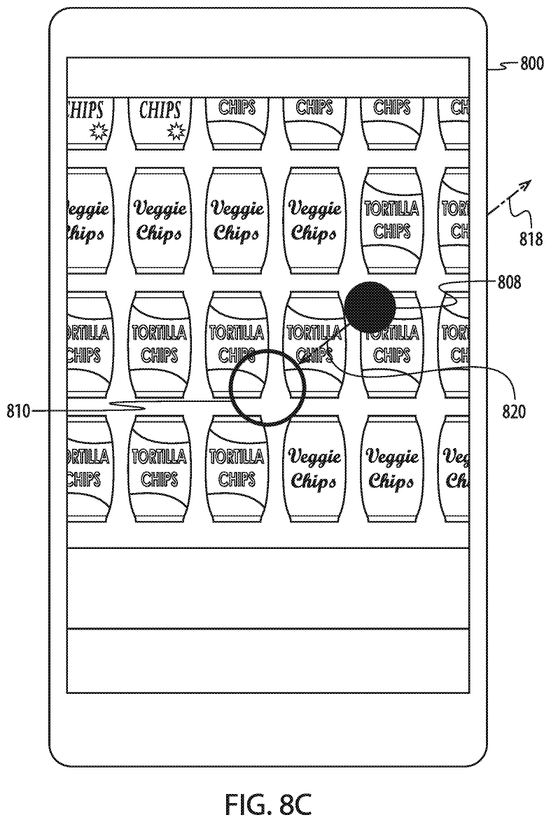

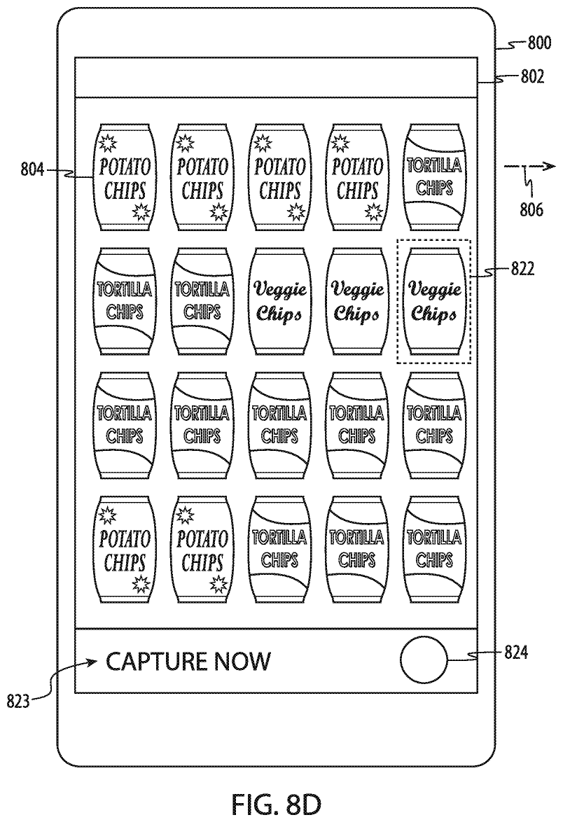

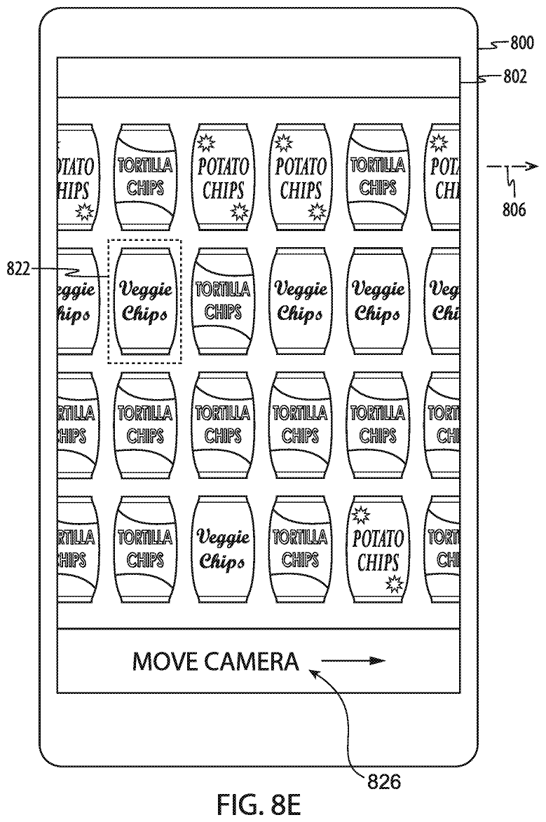

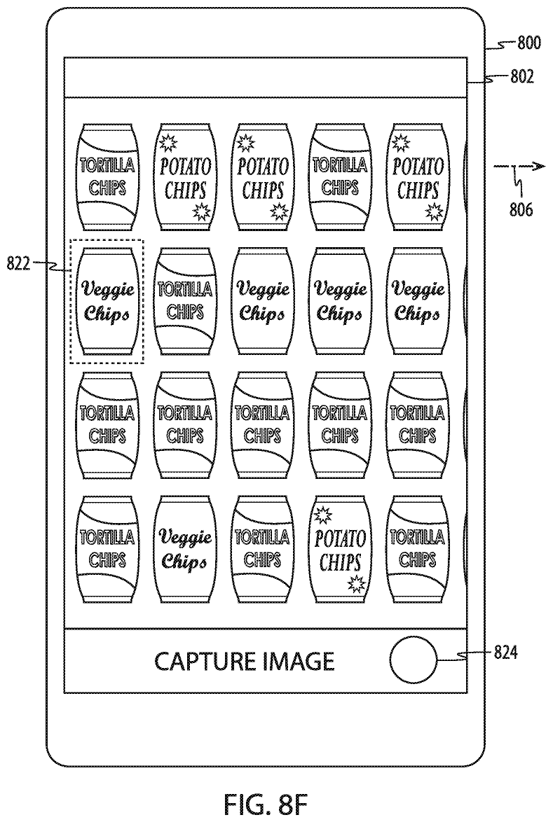

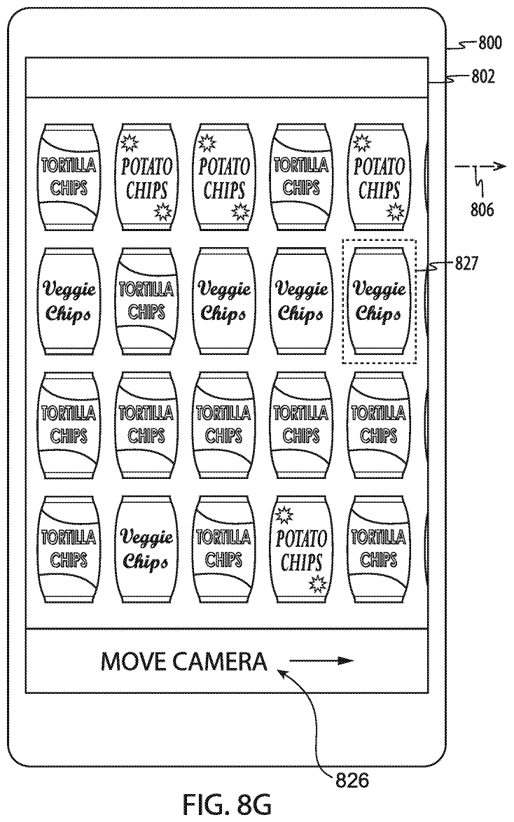

Different types of displays may require different types of image capture techniques. For example, whereas it may be possible to capture images of cold vaults and cold boxes in one frame (or by stitching together two, three, four, or another reasonable number of frames into one composite image), grocery store aisles are typically significantly larger than a single refrigerated display case. Accordingly, it may be inconvenient to take a single image of (or stitch together multiple discretely captured images of) a grocery store aisle. FIGS. 7-8C illustrate example techniques for capturing a grocery store aisle using a video capture technique. As described, after the video is captured an image (e.g., a panoramic image) of the entire aisle, or the portion of interest of the aisle, may be produced and provided for further analysis.

FIG. 7 illustrates an example overhead view of a user 700 in a store aisle 710. The user 700 may use a mobile device 702 with an integrated camera (e.g., a mobile phone, tablet, digital camera, or other device as described herein) to capture a video of a display shelf 705 that includes displayed products or items 712 (e.g., an array of physical items). The user 700 may walk along a path 704 while aiming the camera of the mobile device 702 at the display shelf 705 and capturing a continuous video. Because the video capture is continuous, the user's path 704 need not be linear. For example, the user 700 may be able to walk along the aisle 710 to capture video of a first segment 706 of the display shelf 705, and then turn a corner, while still recording video, to capture video of a second segment 708 of the display shelf 705. In this way, the user may capture a video of multiple segments of a display shelf 705, even when those segments are not continuous along a single linear path. While FIG. 7 shows the user 700 turning one corner and capturing two segments of a display shelf 705, this is merely one example path. In other cases, for example, the user 700 may circumnavigate an entire display shelf by turning around multiple corners. Indeed, due to the continuous video capture, the user 700 may capture display shelves that are curved or have other shapes by simply traversing a path that conforms to the shape of a given shelf.

The device 702 may record location and/or movement data while the user 700 is capturing the video and store that data in association with the video. This data may be used to determine which portions of the video (and/or an image generated from the video) correspond to different segments of the display shelves or aisles. The location and/or movement data may be data from sensors such as GPS sensors or systems, accelerometers, gyroscopes, inertial positioning systems, tilt and/or rotation sensors, or the like.

FIGS. 8A-8C illustrate an example user interface of a mobile device 800 for capturing video of an aisle or other elongated display shelves (e.g., horizontally elongated, such as a grocery store display shelf). The mobile device 800 is shown as a mobile phone, though the interface may be used on other devices as well, as described herein. The mobile device 800 may display, on a display 802, a preview of the video that is being captured. As shown in FIG. 8A, the image is of a display of potato chip bags 804, though any other item or product may be the subject of the video. The interface may include a target 808 and a reticle 810. The target 808 may be a movable graphical element that is displayed on the display 802 and may occlude or otherwise overlay the video preview. The target 808 may act as a moving indicator of how and/or where the user should move the device 800. More particularly, the user may be prompted or instructed to move the device 800 in a manner that causes the target 808 to move towards and/or into the reticle 810. For example, as the device 800 is moved in the direction 806 (e.g., to the right), the target 808 may move in an opposite direction 812 (e.g., to the left) to indicate that the device 800 is being moved in the correct direction. The device 800 may use sensors to determine how the device 800 is being moved and ultimately to determine how to move the target 808 during device motion. For example, the device 800 may use onboard accelerometers, gyroscopes, inertial positioning systems, tilt and/or rotation sensors, or the like. In some cases, the device 800 uses information from the integrated camera. For example, the device 800 may display the target 808 over a particular portion of the image (e.g., a particular item in the image) and move the target 808 to maintain the target 808 over that portion during device movement.

When the user has moved the device 800 sufficiently to cause the target 808 to be aligned with the reticle 810, the target 808 may move back out of alignment with the reticle 810 to continue to provide a movement target for the user. FIG. 8B illustrates an example motion of the target 808 along a path 814 to an updated position 816. As shown in FIG. 8B, the updated position 816 is aligned horizontally with the reticle 810, indicating that the user has successfully maintained horizontal motion and sufficient vertical alignment of the display. FIG. 8C illustrates an example interface in which the target 808 is indicating that the image is out of alignment and that the user needs to move the device 800 in order to correct the misalignment. For example, the target 808 is shown above and to the right of the reticle 810, reflecting the fact that the camera is pointed too far down and indicating that the user needs to move or tilt the device upwards. By moving the device 800 in the direction 818, the user may bring the target 808 back into alignment with the reticle 810 along the direction 820. In this way, the device 800 can help ensure that the user captures a complete, sufficiently aligned video of the display shelves even as the user is walking along the aisle.

FIGS. 8D-8G illustrate another example technique and user interface for acquiring an image of a scene (such as a grocery store aisle or any display, shelf, refrigerator case, or other scene of interest) by capturing multiple still images of the scene, which can then be stitched or otherwise composited together to form a complete scene for further analysis.

With reference to FIG. 8D, the mobile device 800 may display, on the display 802, a preview of the image that is being captured. As shown in FIG. 8D, the image is of a display of potato chip bags 804, though any other item or product may be the subject of the image. The device 800 may identify an object in the image and use the identified object as a tracking and/or motion guide. For example, the device 800 may identify a particular chip bag in the scene and display an indicator 822 around or otherwise proximate to that chip bag. The device 800 may use object detection algorithms that are provided on the device 800 to identify a distinct object in the image, track the identified object as the camera moves, and maintain the indicator 822 in a static position relative to the identified object even as the identified object moves within the frame.

When the camera is initially aimed at the scene to be captured, as shown in FIG. 8D, the interface may display an image capture button 824 and a prompt 823 requesting the user to capture the image. Once the image is captured, the interface may display a prompt 826, as shown in FIG. 8E, indicating to the user how to move the camera relative to the scene. For example, as shown in FIG. 8E, the prompt may indicate that the user should move the device 800 horizontally to the right (arrow 806). FIG. 8E also shows the image preview translating to the left as a result of the device movement. The indicator 822 may remain around or proximate to the identified object even as the device 800 moves, thereby providing a visual reference point that clearly illustrates the movement of the device 800 and allows the user to ensure that the identified object remains in the preview.

Once the identified object reaches an opposite side of the frame from its starting location, as shown in FIG. 8F, the device 800 may once again display the image capture button 824 and prompt the user to capture another image. More particularly, when the device 800 determines that the image preview has moved a distance that maintains at least a threshold level of overlapping coverage with the previous image, the device 800 will prompt the user to capture another image. By prompting the user to capture the image when the identified object is still in the image preview (and has moved within the image preview), the device 800 may ensure that adjacent images in the sequence of captured images have sufficient overlapping content to allow them to be accurately stitched together to form a composite image.

After the image is captured in FIG. 8F, the device 800 may identify a new object to use as a visual reference, display a visual indicator 827 around or proximate to the new object, and prompt the user to continue to move the device 800 in an appropriate direction (e.g., with prompt 826) to continue to capture images of the scene, as shown in FIG. 8G. The process outlined in FIGS. 8D-8G may be repeated until the device 800 detects that the scene has been fully captured, and/or the user indicates that the scene has been fully captured. The images captured as a result of the process outlined in FIGS. 8D-8G may then be stitched or otherwise composited together, by the device 800 or another system such as the image analysis engine 110, to form a single image of a complete scene.

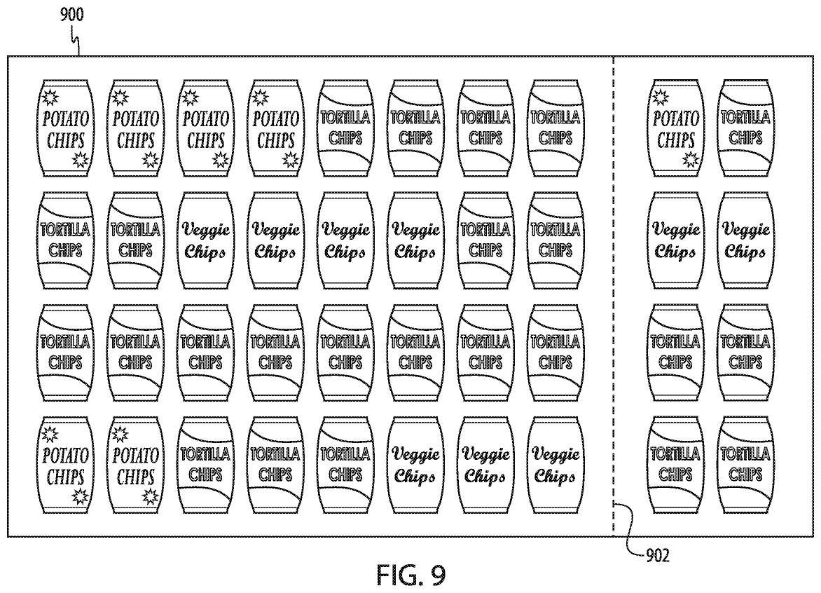

FIG. 9 shows an example image 900 that may be produced from the video captured of an elongated display. The image 900 may be a still image that is derived from or generated using the video captured in accordance with the techniques described above, or by stitching together the still images captured as a result of the process in FIGS. 8D-8G. For example, the image 900 may be generated by stitching together discrete frames of the video (or the still images captured as a result of the process in FIGS. 8D-8G) to form a single image 900, though any suitable technique may be used. The image 900 may include a segment indicator 902 that corresponds to a corner of the display (e.g., where the user turned a corner of an aisle while taking continuous video) or other discontinuity in the image 900. In some cases, the location of the segment indicator 902 is determined based on location and/or motion data associated with the image 900, as described above. For example, the position of the segment indicator 902 may correspond to a position in the video where the mobile device detected that the user changed direction. In addition to or instead of location and/or motion data, the segment indicator 902 may be positioned based on contents of the image, such as a detection, in the image, of a vertical discontinuity or corner of the display shelves. The image 900, or one or more portions thereof, may then be processed as described herein. For example, they may be processed by an image analysis engine to identify items contained in the image. As another example, they may be compared against images of an idealized or target display to determine a compliance metric, such as whether or to what extent an actual display matches the idealized or target display. Any suitable technique may be used, including machine learning models, to analyze the image to produce compliance metrics as described herein.

As noted above, images of arrays of physical items may be analyzed to determine compliance metrics or compliance scores. More particularly, suppliers may have established requirements or targets for how their products are displayed, including how many products are displayed, which types of products are displayed, where they are displayed (e.g., where in a display or shelf), whether they are displayed together or separately, or the like. In some cases, the supplier may establish a planogram for particular products and/or retail stores. Planograms may refer to visual representations of a display of products, and they may represent an ideal or target display arrangement. Compliance metrics for stores, distributors, vendors, or the like may be based on the degree to which their actual displays match a planogram. For example, a store may be in compliance with a planogram if its display matches the planogram exactly or with minor deviations. Conventionally, compliance metrics based on planograms may be determined by an individual manually (e.g., visually) comparing a real-world display, or an image of the display, to a planogram. The individual may compute or otherwise determine a compliance metric for the real-world display and record that metric for further review or tracking purposes.

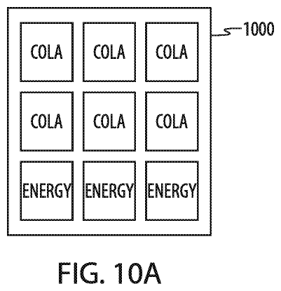

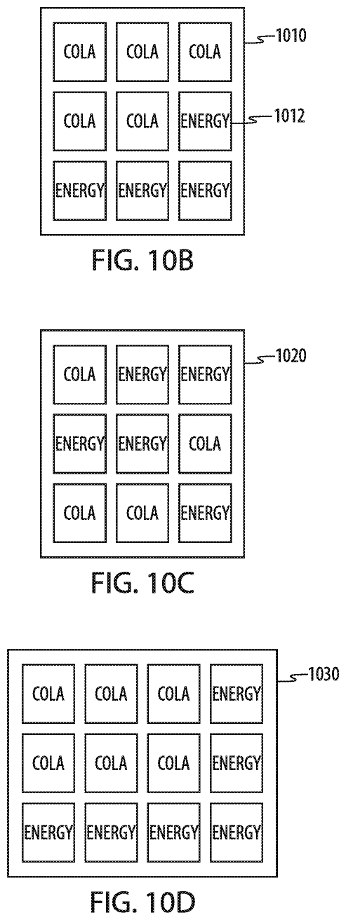

In order to improve the speed and consistency of producing compliance metrics based on planograms, machine learning models may be used to analyze images, such as images captured of a grocery store display shelf or a refrigerated beverage display case, to produce a compliance metric based on the planogram. FIGS. 10A-10D illustrate aspects of a machine learning process for producing compliance metrics based on planograms.

FIG. 10A is an example representation of a planogram matrix 1000. While a conventional planogram may include an artistic rendering of the display, such renderings may not be required for a machine learning technique for generating compliance metrics. The planogram matrix 1000 may indicate the desired locations of beverages in a display case or portion of a display case. For example, the planogram matrix 1000 (also referred to simply as a matrix) may specify that a particular cola product occupies all positions in a top row and a middle row of a display, and that a particular energy drink product occupies all positions in a bottom row of a display.

As shown, the planogram matrix 1000 is a 3×3 matrix, though this is merely exemplary, and a planogram matrix may include any suitable number of rows and columns, as well as non-symmetrical arrangements. Indeed, a planogram matrix may be any representation of products that includes respective product identifiers associated with respective display locations.

The matrix 1000 may represent the target planogram for a particular supplier, and thus may be the target or ideal planogram that a machine learning model is trained with. For example, a compliance metric engine may use a machine learning model to produce compliance metrics that characterize the degree to which a real-world display matches the target planogram. In such cases, the training data for the machine learning model may include a corpus of matrices each associated with a compliance metric or compliance score. The compliance metric may be based on a mathematical model that produces a numerical representation of a deviation between a given display and the target planogram. For example, the compliance metric may be based on a number of products that are out of place, an average distance between each product's target location and each product's actual location, or the like. In other cases, the compliance metric may be based on other techniques, such as a manual review of various real-world scenes. For example, a human operator may assign a compliance metric or score to various example display matrices. Human-assigned metrics or scores may provide a flexible approach to compliance scoring, as a person may make different, more reasoned judgments about the acceptability of a particular deviation from a target planogram.

FIG. 10B illustrates an example item position matrix 1010 (also referred to herein simply as a matrix) that may be manually scored and used as one instance of training data for a machine learning model. The matrix 1010 deviates from the planogram matrix 1000 in that one item 1012 is out of place (e.g., an energy drink appears in one of the positions in the middle row where a cola should be). A human operator may assign a score to the matrix 1010, and the score may be based on any suitable criteria. For example, a supplier (or other individual or entity) may determine that the difference between the matrix 1010 and the planogram 1000 matrix is inconsequential and assign a compliance score of 100%. In other cases, the supplier may determine that the presence of an energy drink on the cola row is significantly detrimental to the presentation of their products and assign the matrix 1010 a compliance score of 50%. Once the matrix 1010 has been scored, it may be added to the corpus of training data for a compliance metric engine.

FIG. 10C illustrates an example matrix 1020 in which the colas and the energy drinks are interspersed in a more disorderly manner. The matrix 1020 may also be assigned a compliance score as described above. Here, the substantial deviation between the planogram matrix 1000 and the matrix 1020 may earn the matrix 1020 a score of 10% or 0%. Of course, other scores may be assigned. Once the matrix 1020 has been scored, it may be added to the corpus of training data for the compliance metric engine.

When trained on a suitable large corpus of training data, the compliance metric engine may be able to generate a compliance metric or score for new product matrices. For example, a user may capture an image of a refrigerated beverage display (e.g., a 3×3 arrangement of beverages), and the captured image may be processed to identify the products in the image and the locations of the products (e.g., with an image analysis engine as described herein). This information may be stored as or may be converted to a sample matrix similar to those represented in FIGS. 10A-10C. The sample matrix may be supplied to the compliance metric engine which uses its trained machine learning models to produce a compliance score for the sample matrix. Because the machine learning model may be trained using compliance scores that are manually assigned (e.g., they need not be determined by a mathematical calculation), it is possible for different suppliers to easily tailor the compliance metric engine to their own preferences for compliance with a target planogram.

In some cases, a planogram may be specified for a three-column arrangement of beverages, but some stores may have displays with other configurations, such as a four-column display. The machine learning model of a compliance metric engine may be configured to accommodate such non-matching matrices and still produce a compliance metric. To facilitate this functionality, the training data may include matrices of shapes and/or sizes that are different than the planogram matrix 1000. For example, FIG. 10D illustrates an example matrix 1030 with four columns and three rows. Despite the matrix 1030 not matching the 3×3 layout of the planogram matrix 1000, a score may be attributed to the matrix 1030. For example, because the arrangement of beverages in the matrix 1030 is largely similar to that of the planogram matrix 1000, the matrix 1030 may be associated with a score of 90%. The training data may include multiple instances of matrices that do not match the planogram matrix, thus allowing the compliance metric engine to produce compliance metrics or scores for many different displays based on a single planogram. Indeed, the flexibility of the machine learning model may allow the compliance metric engine to produce scores for matrices that are not in the training data.

The training data for the machine learning model of the compliance metric engine may be any suitable type of data. For example, the matrices to which scores are associated (e.g., the matrices 1010, 1020, 1030) may correspond to real-world displays. As another example, a computer may generate an assortment of hypothetical arrangements that then may be scored by a user.

The machine learning techniques of the compliance metric engine may be used to produce compliance metrics for planograms (or other target arrangements) of any suitable products. For example, a compliance metric engine may be configured to compare matrices derived from images of cold vaults (e.g., FIGS. 2A-4D) against a planogram for a supplier's beverages. As another example, a compliance metric engine may be configured to compare matrices derived from images of grocery store aisles (e.g., FIGS. 7-9) against a planogram for a supplier's potato chip products. Other products and other display types are also possible. Indeed, compliance metric engines may be provided for producing scores relative to planograms for any type of product (e.g., packaged food, produce, hardware, clothing, electronics, books, medicine, toys).

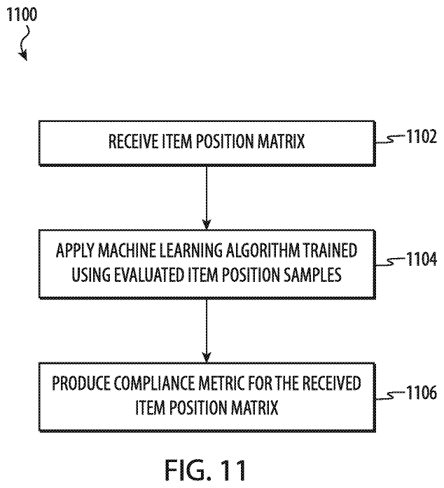

FIG. 11 is a flow chart of an example process 1100 that may be used by a server (e.g., the remote server 102) to produce compliance metrics using a compliance metric engine as described herein. At operation 1102, an item position matrix may be received. The item position matrix may be produced based on the results of the product recognition process(es) described above. For example, once an image is captured by a user in the field, the image may be processed using an image analysis engine to identify the items and the locations of the items in the image. An item position matrix may be generated based on the data from the image analysis engine and provided to the compliance metric engine.

At operation 1104, a machine learning model trained using evaluated item position matrix samples (as described with respect to FIGS. 10A-10D) may be applied to the item position matrix received at operation 1102. The machine learning model may produce a compliance metric for the received item position matrix (operation 1106). The compliance metric may be any suitable compliance metric and may have any suitable form, such as a letter grade (e.g., A-F), a percentage (e.g., 0%-100%), or any other suitable score (e.g., pass/fail; 1-10 scale, 1-5 scale, etc.). Indeed, the compliance metric produced at operation 1106 may correspond to whatever scoring system was used to score the sample matrices of the training data. As noted above, the machine learning model(s) of the compliance metric engine may be based on artificial neural networks, support vector machines, Bayesian networks, genetic algorithms, or the like, and may be implemented using any suitable software, including but not limited to Google Prediction API, NeuroSolutions, TensorFlow, Apache Mahout, PyTorch, or Deeplearning4j.

Another area where automated item recognition may be employed to assist in capturing marketing data is restaurant menus. Menus represent an opportunity for suppliers and producers of products to get brand recognition and earn brand loyalty. For example, menus may specify particular brands of products and thus act as a useful marketing and advertisement vector for brands and/or suppliers. In some cases, representatives of a supplier are paid for each mention of the supplier's brand name on a restaurant's menu. Conventionally, analyzing menus to determine how many times a product is mentioned and determining appropriate incentives has been a manual, time consuming process.

Accordingly, described herein are techniques for automating menu item recognition and analysis. For example, a user, such as a sales representative for a beverage supplier, may capture images of menus at their client's locations. The captured images may be associated with the user's location (e.g., using GPS systems or other positioning systems of the user's device) and then sent to a remote server for processing. The remote server may automatically identify text in the menu and assign categories to the identified text. The remote server may then identify individual mentions of products, brands, or other words and then store and/or display data about the individual mentions of the products or brands. For example, the remote server may determine that a particular product was mentioned by name five times in a menu, and associate that data with the user who captured the image of the menu. The remote server may also associate other data with the information from the menu, such as the name and location of the restaurant associated with the menu, the date that the image of the menu was captured, and the like.

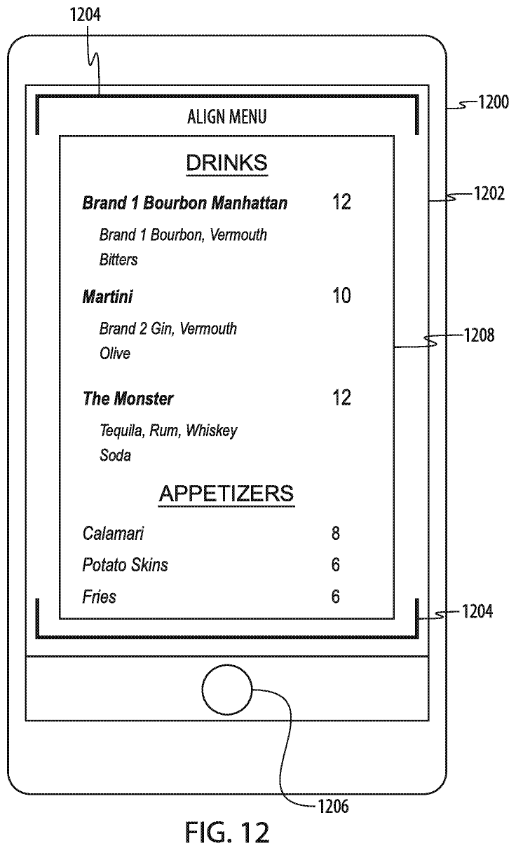

FIG. 12 illustrates an example interface for capturing an image of a menu with a mobile device 1200 having an integrated camera. The device 1200 (which may be a mobile phone, tablet computer, digital camera, or the like) may present alignment guides 1204 on a display 1202. The user may align the menu 1208 in the camera's field of view using the alignment guides 1204, and capture an image of the menu by pressing an image capture button 1206. Once the image of the menu 1208 is captured, it may be sent to a remote server (e.g., the remote server 102, FIG. 1A) for processing, or it may be processed on the user's mobile device 1200.

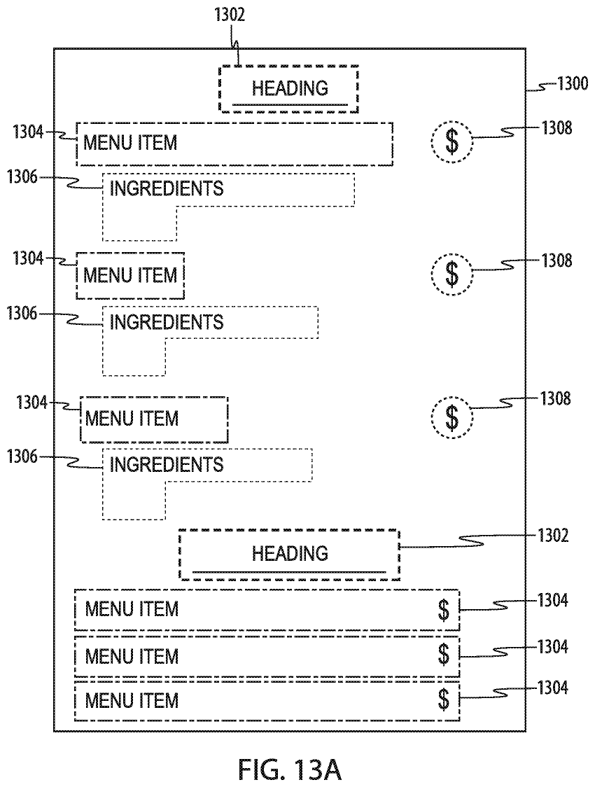

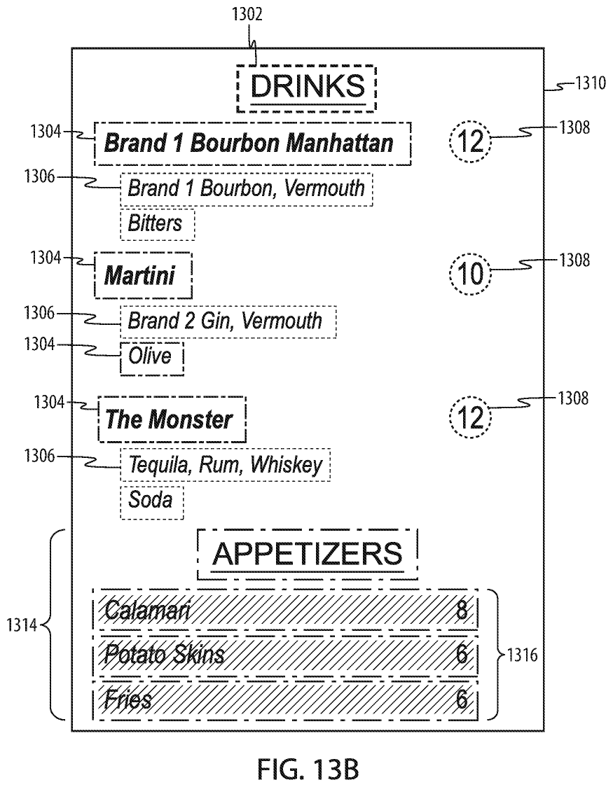

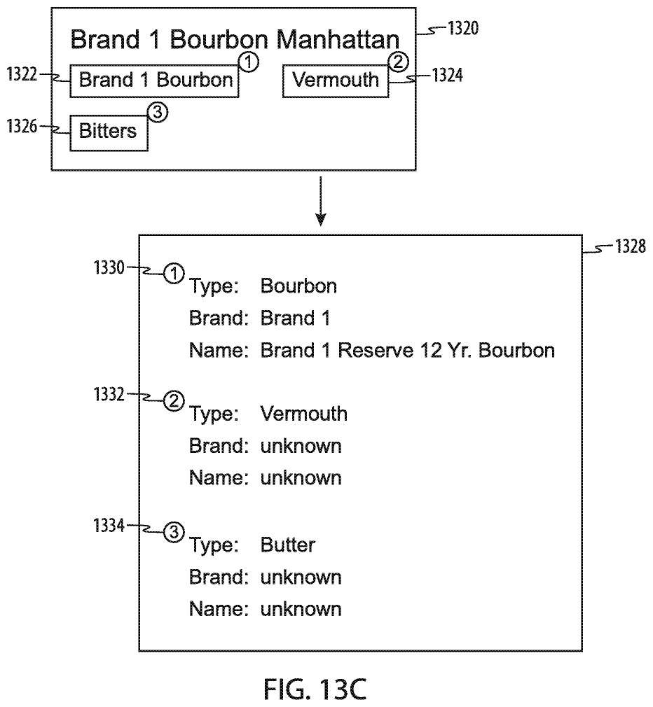

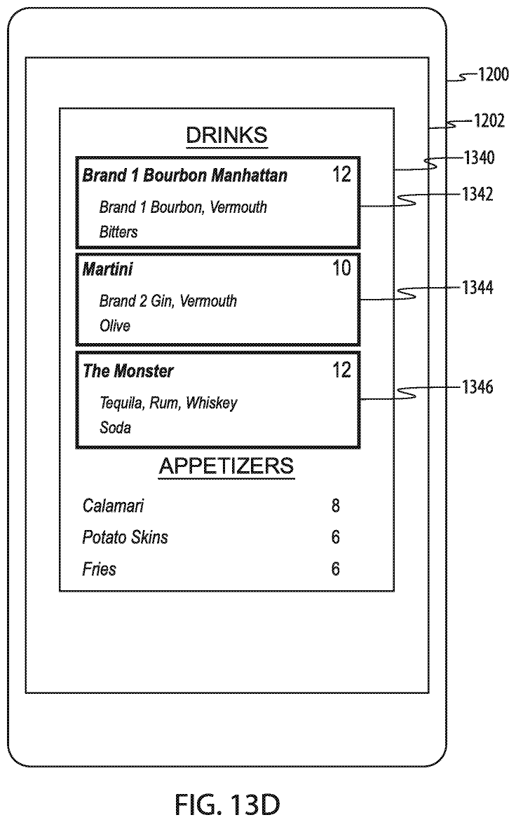

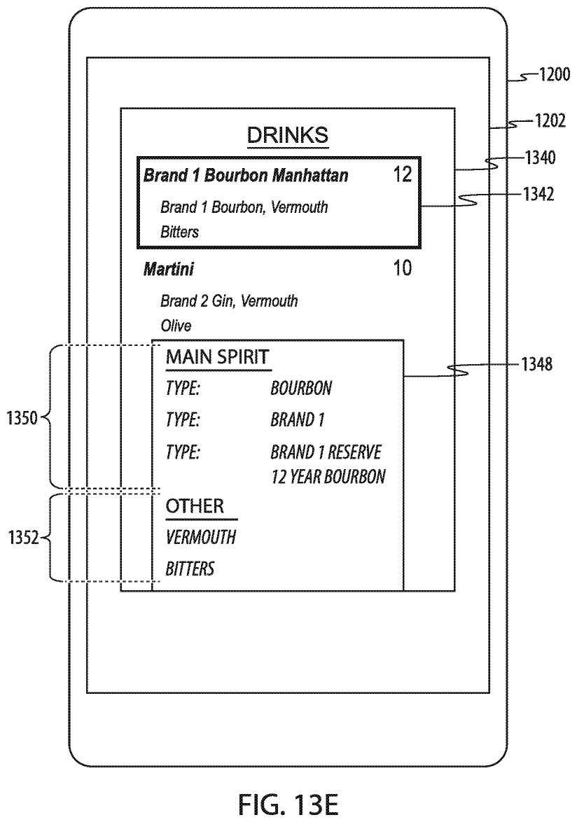

FIG. 13A illustrates an example image of a menu 1300 (corresponding to an image captured of the menu 1208) at a stage of analysis to determine the contents of the menu. In particular, after the image is captured, it may be analyzed to identify regions that may correspond to text of interest. At this stage, the actual contents of the text may not be analyzed. Instead, areas of interest may be identified, for example, based on colors, a determination that an area includes some text (though the text may not be analyzed), a size of the features that are determined to be text, or the like. Machine learning models may be trained using images of menus or other text documents in which the regions containing text are manually identified.

The results of this analysis may associate the various text regions with various categories. For example, the text regions that are likely to be menu section headings may be tagged as “heading” 1302, the text regions that are likely to be menu item names may be tagged as “menu item” 1304, ingredients of the menu items may be tagged as “ingredients” 1306, and prices may be tagged as “$” 1308. Other suitable tags may also be added at this stage of the menu analysis. The results of the tagging operation may inform how the menu analysis process continues. For example, regions that are deemed to be likely irrelevant to further analysis (e.g., menu section headings, food safety warnings) may be ignored in future analysis steps. In some cases the image as annotated in FIG. 13A may be displayed to a user, or it may not. Indeed, the image as shown in FIG. 13A is for explanatory purposes and no actual viewable image may be produced with this information included.

FIG. 13B illustrates an example image 1310 of the menu after a text recognition and analysis process. In some cases, the text recognition process is performed without first performing a categorization operation as described above with respect to FIG. 13A. In such cases, the image of the menu may be processed to identify and recognize any text in the menu. If the categorization operation was performed, only those regions that were determined to be relevant or potentially relevant may be analyzed. As another example, the text recognition process may be performed on all regions that were identified to likely contain text, but not on the regions of the image that were determined not to contain text.

The text recognition and analysis process that results in the image 1310 may include an optical character recognition process to determine what letters are contained in each item of text and a semantic analysis process to determine a proposed category for each item of text. The semantic analysis may use natural language processing techniques to determine the text categories (e.g., statistical natural language processing, rule-based natural language processing, machine-learning based natural language processing, etc.). Once the text categories are determined for each item of text, an image may be annotated to indicate the categories of each item of text. Where a categorization operation was previously performed, the categorization based on the semantic contents of the text items may serve to confirm or disconfirm the previous categorization of a given item of text. Where the categorization operation was not previously performed, the text recognition and analysis process may be the primary technique for categorizing the text items.

As shown in FIG. 13B, the text items may be highlighted, framed, or otherwise distinctively displayed to indicate the category of the text. For example, menu headings, menu items, ingredients, and prices may all be associated with a unique embellishment. Some suppliers may be interested only in some types of menu items. For example, a beverage supplier may not be interested in anything relating to food items. Thus, text items determined to be irrelevant (e.g., the “Appetizers” section 1314 of the menu in FIG. 13B) may be shown with another unique embellishment to indicate the irrelevance to users. In cases where some text item was not even subjected to a text recognition and analysis process, those text items may be greyed-out, as shown for the appetizer items 1316 in FIG. 13B. This may occur, for example, in response to the categorization operation indicating that a text item is unlikely to be of interest, or in response to the text recognition and analysis process determining that subsequent text items are unlikely to be of interest (e.g., once the “Appetizers” section of the menu starts, the following text may not be of interest to the beverage supplier and the following text may be ignored).

Once an image is annotated as shown, it may be displayed to an operator for review. In some cases, it may be displayed to the user who captured the image of the menu (such as on the same device that was used to capture the menu image), or it may be displayed to another operator, manager, auditor, or the like. The operator may then determine whether the categorization is accurate and make any necessary changes. For example, the image 1310 shows the ingredient “olive” as corresponding to a “menu item” category 1304 rather than an “ingredient” category 1306. The operator may recategorize any text that was miscategorized by the text recognition and analysis process. For example, the operator may select the miscategorized item (e.g., by pressing or clicking the text or other associated region) and enter the proper category.

Once the menu is properly categorized, it may be submitted for item recognition processing. At this stage, which may be considered part of the text recognition and analysis process, product information is associated with particular ingredients or menu items. FIG. 13C illustrates how product information may be associated with menu items. For example, the different ingredients of the menu item shown in region 1320 of the menu, corresponding to the first drink in the menu (e.g., a “Brand 1 Bourbon Manhattan”), are individually identified. Specifically, the ingredient list includes “brand 1 bourbon” 1322, “vermouth” 1324, and “bitters” 1326. Product information may be associated with each ingredient in a data structure 1328. The text recognition and analysis process may attempt to determine as much information as possible about each text item, including information such as the type of ingredient, the brand, the specific product name, a UPC code, or the like. As shown, data entry 1330, corresponding to the “brand 1 bourbon” ingredient, includes the type, brand, and name of the bourbon. This information may be determined based on natural language processing techniques as well as by looking up product information in a database. For example, while the menu may not contain the entire name of the bourbon, a database lookup may reveal that brand 1 bourbon makes only one bourbon, and therefore that name can be correctly associated with that ingredient. Where specific brands or product names cannot be identified, they may be left blank. For example, data entry 1332 indicates that the ingredient 1324 is a vermouth, but does not include the brand or product name of the vermouth.

The data structure 1328 may also allow an operator to identify and correct errors that may have occurred during the text recognition and analysis process. For example, the text “bitters” in the ingredient list may have been incorrectly recognized as the word “butter.” Accordingly, an operator may review the data structure 1328 in conjunction with an image of the menu region 1320 and determine that the ingredient “butter” is incorrect. The user may be able to correct the ingredient type in data entry 1334 to the correct “bitters.”

Once the product information has been confirmed to be correct, data from the menu may be analyzed to determine, for example, how many mentions of a particular brand or product are in a menu, whether incentive targets have been reached, and the like. In some cases, no product information confirmation process is performed.

FIG. 13D illustrates an example interface for displaying the results of a menu analysis operation to a user. For example, an image 1340 of the menu may be displayed on the display 1202 of the device 1200. The menu image 1340 may include indicators 1342, 1344, 1346 displayed around or otherwise associated with certain regions that contain text that has been analyzed. In the example shown in FIG. 13D, the text corresponds to discrete drinks on a cocktail menu, though this is merely one example of the type of region or text that may be identified by the indicators 1342, 1344, 1346. The indicators 1342, 1344, 1346 may indicate to the user that those regions can be selected (e.g., by touching or pressing on the display 1202) to call up additional information about the analyzed text. Notably, the indicators 1342, 1344, 1346 may be displayed over an actual image of the menu, thus allowing the user to see the original text of the menu in the image. The user may also be able to zoom in and out on the menu image to better read the text or select the indicators 1342, 1344, 1346.

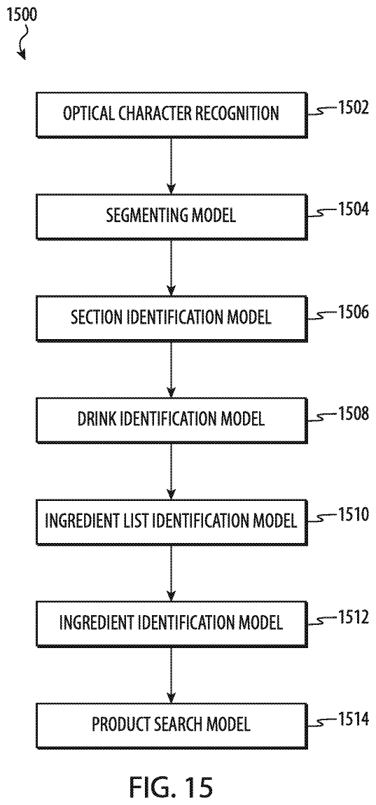

FIG. 13E illustrates the interface of FIG. 13D after a user has selected the first indicator 1342, corresponding to the drink titled “Brand 1 Bourbon Manhattan.” Selection of the first indicator 1342 caused a window 1348 to be displayed, with the window containing information about the menu item. The information about the menu item may have been determined by the image analysis engine 110, and more particularly, by the image segmentation engine 114 and the segment identification engine 116 applying appropriate machine learning models to the text of the menu. Additional details of the machine learning models for analyzing menu text is described herein with reference to FIG. 15.

The window 1348 may display various types of information, depending on factors such as the type of menu item, the contents of the menu item, and the like. In the case of cocktails, the information in the window 1348 may include a “main spirit” section 1350, which may be the main or first ingredient in the cocktail. The status of an ingredient as the main spirit may be determined using the machine learning models of the image analysis engine 110. The main spirit information 1350 may include a spirit type (e.g., bourbon, gin, vodka), a brand, and a name of the exact spirit or product. The window 1348 may also include an “other ingredient” section 1352 that lists information about other ingredients. In some cases, the other ingredient section 1352 displays information about all of the ingredients that are not the main ingredient or main spirit. In other cases, the “other ingredient” section 1352 displays only non-spirit ingredients (e.g., juices, sodas, bitters, etc.), while any secondary sprit ingredients may be displayed in a separate section.

Metrics relating to the contents of a whole menu (and/or multiple menus) may also be compiled and made available for review. For example, the server 102 may determine how many drinks in a given menu (or group of menus) include spirits that are supplied by a given supplier. Such information may be used to determine compliance with sales or marketing targets or quotas, or the like.

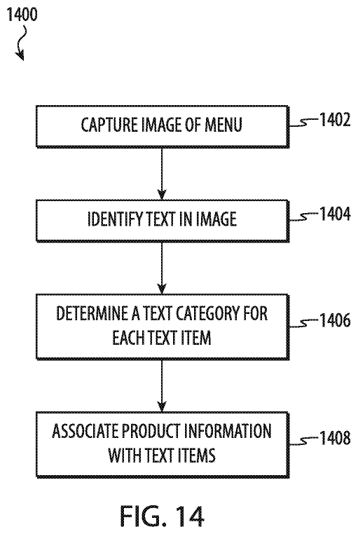

FIG. 14 is a flow chart of an example process 1400 for associating product information with text items in menus or other text-based displays (e.g., table tents, chalkboard menus, sandwich boards, and the like). The operations of the process 1400 may be performed by one or more computers and/or computing systems. For example, the process 1400 may be performed by a server (e.g., the remote server 102, FIG. 1A) or a mobile device (e.g., the mobile device 101-1, FIG. 1A). In some cases, some of the operations are performed on a server and some are performed on a mobile device.

At operation 1402 an image of a menu is captured, as described with respect to FIG. 12. The image may be captured by a mobile device with an integrated camera, such as a mobile phone, as described herein. A location of the mobile phone when the image is captured may be associated with the captured image. In cases where processing and analysis of the image is performed by a server, the captured image may be sent from the mobile device to a remote server.

At operation 1404 text is identified in the image. This may include performing optical character recognition (OCR) on all or some of the image, as described with respect to FIG. 13B. In some cases, prior to performing OCR, regions of the image that may correspond to text are identified as described above with respect to FIG. 13A.

At operation 1406, categories for each identified text item are determined and associated with each text item. For example, as described with respect to FIGS. 13A-13B, categories such as “heading,” “menu item,” and “ingredients” may be associated with each text item. The categories may be assigned based on information from an OCR process along with a text analysis process (e.g., natural language processing), where the actual words and their meanings are known (FIG. 13B), or based on information from a text identification process where the actual words in the text are not known (FIG. 13A).

At operation 1408, product information is associated with at least some of the text items in the menu, as described with respect to FIG. 13C. The product information may include, for example, an item type or category, a brand, an item name, a UPC code, a product nickname, or any other suitable information. Product information may be associated with titles of menu items (e.g., a drink name), ingredients of menu items, or any other text found in the menu. The product information may be analyzed to determine how many mentions of a particular product are present on the menu, which category of text contained the mentions (e.g., was the product mentioned in a drink title or an ingredient list), and the like.

FIG. 15 illustrates an example workflow for using machine learning models to analyze text on a menu and associate various different types of information with the text. For example, as noted above, menus may include section headings, menu items, ingredients, prices, and the like. In order to acquire useful data from a menu, machine learning models may be used to determine which text on the menu corresponds to what type of information. In order to produce accurate results, the models may be cascaded in a particular order so that the results of one model can be used as inputs to another model. FIG. 15 illustrates one example order of machine learning models that may be used to analyze a menu.

At operation 1502, an image of the menu may be subjected to optical character recognition (OCR) to produce computer-readable text for subsequent analysis. The computer-readable text may be overlaid on the image or otherwise associated with the location of the text in the image of the menu.

The menu image, along with the computer-readable text, may be provided to a segmenting model 1504. The segmenting model 1504 may identify which areas of the menu appear to correspond to discrete regions of text, such as coherent lines of text. The segmenting model 1504 may also determine which text should be associated together. For example, the segmenting model 1504 may determine which items of text are likely to be part of a single menu item. As one particular example, a menu may be arranged with drinks arranged in two side-by-side columns, where each drink has multiple lines of ingredients or description. As such, defining an entire line of text, from one side of the menu to the other, as a single segment may incorrectly combine the contents of two different drinks. Accordingly, the segmenting model 1504 may determine that a segment of text should include multiple partial lines of text, thereby correctly reflecting the columned arrangement of the drinks and providing more accurate data for subsequent models.

The segmenting model 1504 may be trained on a corpus of menus whose text has been manually segmented into discrete segments. The segmenting model 1504 may use optical or visual information to determine the segments (e.g., the presence of spaces greater than a certain distance between text objects may suggest that those text objects belong to different segments, different text size or fonts may also suggest that those text objects belong to different segments), as well as textual information (e.g., the actual semantic content of the text).

Once segmented, the menu image, text, and segment information may be provided to a section identification model 1506. The section identification model 1506 may assign different segments to different menu sections. Menu sections may correspond to headings such as “drinks,” “appetizers,” “main courses,” or the like. The section identification model 1506 may be trained on a corpus of menus where the section labels have been manually applied to the text in the menu.

The workflow may then progress to a drink identification model 1508. The drink identification model 1508 may determine which segments correspond to discrete drinks, and may assign discrete drinks to their appropriate menu sections. For example, the drink identification model 1508 may determine which segments define discrete cocktails, and then label those segments as defining a single cocktail. The identified drinks may then be associated with a “cocktails” menu section. The drink identification model 1508 may be trained on a corpus of segments that have been manually associated with discrete drink identifiers.

The workflow may then progress to an ingredient list identification model 1510, which may identify which portions of the text associated with a drink correspond to the ingredient list (as opposed to a drink title or drink description). The ingredient list identification model 1510 may be trained on a corpus of segments that are associated with discrete drinks and whose ingredient lists have been manually labeled as ingredient lists.

The ingredient lists may be provided to an ingredient identification model 1512, which determines which words in the ingredient lists correspond to which ingredients. For example, “simple” may be identified as corresponding to “simple syrup” and “orange” may be identified as “orange juice.” Other ingredients, including spirits, may also be identified by the ingredient identification model 1512. The ingredient identification model 1512 may be trained on a corpus of drink text where the ingredient text has been manually labeled with corresponding ingredients.

The ingredients may then be provided to a product search model 1514, which associates UPCs or other product identifiers with the ingredients from the ingredient identification model 1512. For example, an ingredient of “Brand 1 12 year old Bourbon” may be associated with the UPC of that particular product. In some cases, the product search model 1514 may use a lookup table or other scheme instead of a machine learning model.

The workflow 1500 may be implemented, in whole or in part, by the image segmentation engine 114 and/or the segment identification engine 116. The results of the workflow 1500 may be used to provide menu analysis results and other data for review and/or storage, such as shown and described with respect to FIGS. 13A-13E.

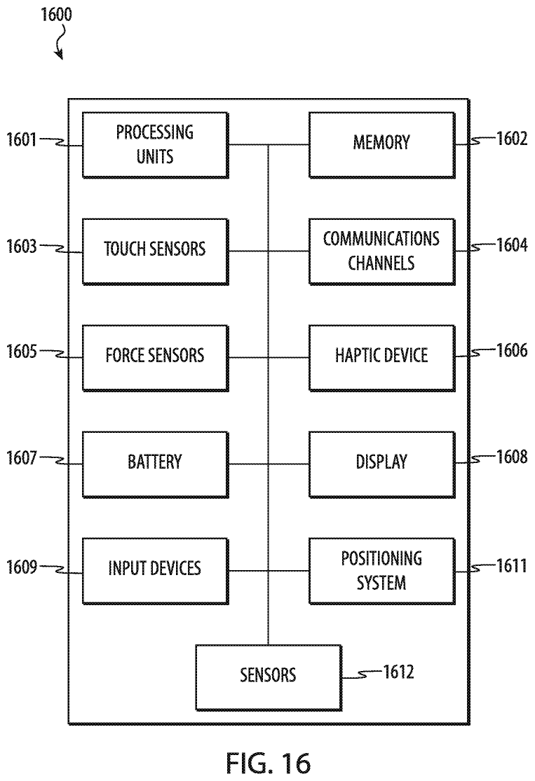

FIG. 16 depicts an example schematic diagram of an electronic device 1600. The electronic device 1600 may be an embodiment of or otherwise represent any of the electronic devices described herein, such as the mobile devices 101, the remote server(s) 102, the supplier server 108, or the like. The device 1600 includes one or more processing units 1601 that are configured to access a memory 1602 having instructions stored thereon. The instructions or computer programs may be configured to perform one or more of the operations or functions described with respect to the electronic devices described herein. For example, the instructions may be configured to control or coordinate the operation of one or more displays 1608, one or more touch sensors 1603, one or more force sensors 1605, one or more communication channels 1604, one or more input devices 1609, one or more positioning systems 1611, and one or more sensors 1612.

The processing units 1601 of FIG. 16 may be implemented as any electronic device capable of processing, receiving, or transmitting data or instructions. For example, the processing units 1601 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 1602 can store electronic data that can be used by the device 1600. For example, a memory can store electrical data or content such as, for example, audio and video files, images, documents and applications, device settings and user preferences, programs, instructions, timing and control signals or data for the various modules, data structures or databases, and so on. The memory 1602 can be configured as any type of memory. By way of example only, the memory can be implemented as random access memory, read-only memory, Flash memory, removable memory, or other types of storage elements, or combinations of such devices.

The touch sensors 1603 may detect various types of touch-based inputs and generate signals or data that are able to be accessed using processor instructions. The touch sensors 1603 may use any suitable components and may rely on any suitable phenomena to detect physical inputs. For example, the touch sensors 1603 may be capacitive touch sensors, resistive touch sensors, acoustic wave sensors, or the like. The touch sensors 1603 may include any suitable components for detecting touch-based inputs and generating signals or data that are able to be accessed using processor instructions, including electrodes (e.g., electrode layers), physical components (e.g., substrates, spacing layers, structural supports, compressible elements, etc.) processors, circuitry, firmware, and the like. The touch sensors 1603 may operate in conjunction with the force sensors 1605 to generate signals or data in response to touch inputs. A touch sensor or force sensor that is positioned over a display surface or otherwise integrated with a display may be referred to herein as a touch-sensitive display, force-sensitive display, or touchscreen.

The force sensors 1605 may detect various types of force-based inputs and generate signals or data that are able to be accessed using processor instructions. The force sensors 1605 may use any suitable components and may rely on any suitable phenomena to detect physical inputs. For example, the force sensors 1605 may be strain-based sensors, piezoelectric-based sensors, piezoresistive-based sensors, capacitive sensors, resistive sensors, or the like. The force sensors 1605 may include any suitable components for detecting force-based inputs and generating signals or data that are able to be accessed using processor instructions, including electrodes (e.g., electrode layers), physical components (e.g., substrates, spacing layers, structural supports, compressible elements, etc.) processors, circuitry, firmware, and the like. The force sensors 1605 may be used in conjunction with various input mechanisms to detect various types of inputs. For example, the force sensors 1605 may be used to detect presses or other force inputs that satisfy a force threshold (which may represent a more forceful input than is typical for a standard “touch” input). The force sensors 1605 may operate in conjunction with the touch sensors 1603 to generate signals or data in response to touch- and/or force-based inputs. The touch and/or force sensors may be provided on the mobile devices 101 described herein to facilitate the manipulation of a user interface for capturing images, viewing compliance metrics or other data, and the like.

The one or more communication channels 1604 may include one or more wired and/or wireless interface(s) that are adapted to provide communication between the processing unit(s) 1601 and an external device. The one or more communication channels 1604 may include antennas, communications circuitry, firmware, software, or any other components or systems that facilitate wireless communications with other devices. In general, the one or more communication channels 1604 may be configured to transmit and receive data and/or signals that may be interpreted by instructions executed on the processing units 1601. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces, TCP/IP interfaces, network communications interfaces, or any conventional communication interfaces.

As shown in FIG. 16, the device 1600 may include a battery 1607 that is used to store and provide power to the other components of the device 1600. The battery 1607 may be a rechargeable power supply that is configured to provide power to the device 1600. The battery 1607 may be coupled to charging systems (e.g., wired and/or wireless charging systems) and/or other circuitry to control the electrical power provided to the battery 1607 and to control the electrical power provided from the battery 1607 to the device 1600.

The device 1600 may also include one or more displays 1608 configured to display graphical outputs. The displays 1608 may use any suitable display technology, including liquid crystal displays (LCD), organic light emitting diodes (OLED), active-matrix organic light-emitting diode displays (AMOLED), or the like. The displays 1608 may display graphical user interfaces, images, icons, or any other suitable graphical outputs. The displays 1608 may be integrated into a single computing device (e.g., as in a mobile device (e.g., smartphone or tablet), or an all-in-one computer), or it may be a peripheral device that is coupled to a separate computing device.

The device 1600 may also include one or more input devices 1609. The input systems 1609 may include pointing devices (e.g. mice, trackballs, etc.), keyboards, touchscreen interfaces, drawing tablets, microphones, etc. The input devices 1609 may facilitate human operator interaction and/or control of the electronic device 1600.

The device 1600 may also include a positioning system 1611. The positioning system 1611 may be configured to determine the location of the device 1600. For example, the positioning system 1611 may include magnetometers, gyroscopes, accelerometers, optical sensors, cameras, global positioning system (GPS) receivers, inertial positioning systems, or the like. The positioning system 1611 may be used to determine a location of a mobile device, such as to geotag an image captured at a retail store or to facilitate a location selection operation (FIG. 2A).

The device 1600 may also include one or more additional sensors 1612 to receive inputs (e.g., from a user or another computer, device, system, network, etc.) or to detect any suitable property or parameter of the device, the environment surrounding the device, people or things interacting with the device (or nearby the device), or the like. For example, a device may include temperature sensors, biometric sensors (e.g., fingerprint sensors, photoplethysmographs, blood-oxygen sensors, blood sugar sensors, or the like), eye-tracking sensors, retinal scanners, humidity sensors, buttons, switches, lid-closure sensors, or the like.

To the extent that multiple functionalities, operations, and structures described with reference to FIG. 16 are disclosed as being part of, incorporated into, or performed by the device 1600, it should be understood that various embodiments may omit any or all such described functionalities, operations, and structures. Thus, different embodiments of the device 1600 may have some, none, or all of the various capabilities, apparatuses, physical features, modes, and operating parameters discussed herein. Further, the systems included in the device 1600 are not exclusive, and the device 1600 may include alternative or additional systems, components, modules, programs, instructions, or the like, that may be necessary or useful to perform the functions described herein.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above and below, or their synonyms, do not necessarily refer to an absolute position relative to an external reference, but instead refer to the relative position of components with reference to the figures.

What is claimed is:

1. A method of capturing and providing, with a mobile device, images of retail products for analysis by a remote image analysis engine applying one or more machine learning models, comprising:
at a mobile device comprising a processor, a memory, a display, and an integrated camera:
prompting a user to capture an image of an array of physical items;
capturing the image with the integrated camera;
sending the captured image to a remote server;
receiving, from the remote server:
an image annotation data set defining an array of segments, each segment corresponding to a physical item in the array of physical items and having an associated product information, a given associated product information determined using a trained product model that identifies a product identifier based on a portion of the image that corresponds to a given segment of the image; and
information representing an amount of the physical items in the array of physical items that are associated with a particular product identifier;
displaying, on the display, an annotated image based on the captured image and the image annotation data set received from the remote server; and
displaying, on the display, the information representing the amount of the physical items in the array of physical items that are associated with the particular product identifier.

2. The method of claim 1, wherein
the trained product model is a first trained product model; and
the segments are determined by providing the image as an input to a second trained product model and receiving, from the second trained product model, a segmented image in which each segment corresponds to a physical item in the array of physical items.

3. The method of claim 1, the method further comprises:
displaying a preview image of a physical item in the annotated image;
prompting the user to associate a verified product identifier with the preview image;
receiving the verified product identifier;
sending the verified product identifier to the remote server; and
receiving, from the remote server, updated information representing the amount of the physical items in the array of physical items that are associated with the particular product identifier.

4. The method of claim 1, the method further comprises:
displaying a preview image of a physical item in the annotated image;
prompting the user to capture an image of a barcode of the physical item; and
capturing the image of the barcode using a camera function of the mobile device.

5. The method of claim 4, further comprising sending the image of the barcode to the remote server.

6. The method of claim 4, further comprising:
determining a product identifier from the image of the barcode; and
sending the product identifier to the remote server to be associated with the preview image of the physical item in the annotated image.

7. The method of claim 1, further comprising:
receiving, from the remote server, compliance information representing a comparison between the amount of the physical items in the array of physical items that are associated with the particular product identifier and a target amount; and
displaying the compliance information on the display.

8. The method of claim 7, further comprising:
receiving, from the remote server, an action item associated with the particular product identifier, wherein compliance with the action item will reduce a difference between the amount of the physical items in the array of physical items that are associated with the particular product identifier and the target amount.

9. The method of claim 7, wherein the compliance information further represents a comparison between locations of the physical items in the array of physical items that are associated with the particular product identifier and target locations.

10. The method of claim 1, further comprising, at the mobile device:
prompting the user to capture an additional image of an additional array of physical items;
capturing the additional image with the integrated camera;
sending the additional image to the remote server;
receiving, from the remote server:
an additional image annotation data set representing an additional array of segments each corresponding to a physical item in the additional array of physical items and having an associated product identifier; and
additional information representing an amount of the physical items in the additional array of physical items that are associated with a particular product identifier;
displaying, on the display, an additional annotated image based on the additional image and the additional image annotation data set received from the remote server; and
displaying, on the display, the additional information representing the amount of the physical items in the additional array of physical items that are associated with the particular product identifier.

11. The method of claim 10, further comprising:
combining the information representing the amount of the physical items in the array of physical items that are associated with the particular product identifier and the additional information representing the amount of the physical items in the additional array of physical items that are associated with the particular product identifier; and
displaying the combined information on the display.

12. A method of analyzing images of physical items captured via a mobile device, comprising:
receiving, at a server and via a mobile device, a digital image of an array of products;
determining, in the digital image, a plurality of segments, each segment corresponding to a product in the array of products;
for a segment of the plurality of segments:
determining a candidate product identifier; and
determining a confidence value of the candidate product identifier;
if the confidence value satisfies a condition:
associating the candidate product identifier with the segment; and
sending candidate product information, based on the candidate product identifier, to the mobile device for display in association with the segment; and
if the confidence value fails to satisfy the condition, subjecting the segment to a manual image analysis operation.

13. The method of claim 12, further comprising:
receiving, as a result of the manual image analysis operation, a verified product identifier;
associating the verified product identifier with the segment; and
sending verified product information, based on the verified product identifier, to the mobile device for display in association with the segment.

14. The method of claim 13, wherein:
the operation of determining the plurality of segments in the digital image comprises analyzing the digital image using a machine learning model trained using a corpus of digital images; and
the digital images each include a depiction of a respective array of products and are each associated with a respective plurality of segments, each segment corresponding to an individual product.

15. The method of claim 14, wherein:
the machine learning model is a first machine learning model;
the digital images are first digital images;
the operation of determining the candidate product identifier of the segment comprises analyzing the segment using a second machine learning model trained using a corpus of second digital images; and
the second digital images each include a depiction of a respective product and are associated with a respective product identifier.

16. A method of analyzing images of physical items captured via a mobile device, comprising:
receiving, at a server and via a mobile device, a digital image of an array of products;
determining, in the digital image, a plurality of segments, each segment corresponding to a product in the array of products;
for a first segment of the plurality of segments:
determining a first candidate product identifier;
determining that a confidence value of the first candidate product identifier satisfies a condition; and
in response to determining that the first candidate product identifier satisfies the condition:
associating the first candidate product identifier with the first segment; and
sending first product information to the mobile device for display in association with the first segment, the first product information based on the first candidate product identifier; and
for a second segment of the plurality of segments:
determining a second candidate product identifier;
determining that a confidence value of the second candidate product identifier fails to satisfy the condition; and
in response to determining that the second candidate product identifier fails to satisfy the condition, subjecting the second segment to a manual image analysis operation.

17. The method of claim 16, further comprising:
receiving, as a result of the manual image analysis operation, a verified product identifier;
associating the verified product identifier with the second segment; and
after sending the first product information to the mobile device, sending second product information to the mobile device for display in association with the second segment, the second product information based on the verified product identifier.

18. The method of claim 17, wherein:
the method further comprises, after sending the first product information to the mobile device, generating a composite image in which both the first product information and the second product information are associated with the digital image received via the mobile device; and
sending the second product information to the mobile device includes sending the composite image to the mobile device.

19. A method of analyzing images of physical items, comprising:
at a mobile device with a camera:
capturing, with the camera, a digital image of an array of products;
determining, in the digital image, a plurality of segments, each segment corresponding to a product in the array of products;
for a segment of the plurality of segments:
determining a candidate product identifier; and
determining a confidence value of the candidate product identifier;
if the confidence value satisfies a condition:
associating the candidate product identifier with the segment; and
displaying candidate product information in association with the segment, the candidate product information based on the candidate product identifier; and
if the confidence value fails to satisfy the condition, sending the segment to a remote device for manual image analysis.

20. The method of claim 19, wherein:
the operation of determining the plurality of segments in the digital image comprises analyzing the digital image using a first machine learning model trained using a corpus of first digital images;
the operation of determining the candidate product identifier of the segment comprises analyzing the segment using a second machine learning model trained using a corpus of second digital images; and
the first machine learning model is different than the second machine learning model.
